(19) United States
(12) Patent Application Publication
(10) Pub. No.: US 2023/0401391 A1
(43) Pub. Date: Dec. 14, 2023

(54) MACHINE TRANSLATION METHOD, DEVICES, AND STORAGE MEDIA

(71) Applicant: SAMSUNG ELECTRONICS CO., LTD., Suwon-si (KR)

(72) Inventors: Fan ZHANG, Beijing (CN); Mei TU, Beijing (CN); Song LIU, Beijing (CN)

(73) Assignee: SAMSUNG ELECTRONICS CO., LTD., Suwon-si (KR)

(21) Appl. No.: 18/209,790

(22) Filed: Jun. 14, 2023

Related U.S. Application Data
(63) Continuation of application No. PCT/KR23/07944, filed on Jun. 9, 2023.

(30) Foreign Application Priority Data
Jun. 14, 2022 (CN) 202210674929.7
Oct. 11, 2022 (CN) 202211243383.6

(51) Int. Cl. G06F 40/47; G06F 40/284

(52) U.S. Cl. CPC G06F 40/47; G06F 40/284

(57) ABSTRACT

A method performed by an electronic device comprises acquiring information to be translated. The method includes determining, based on the information to be translated, a target domain adapter from a plurality of candidate domain adapters, the target domain adapter corresponding to the information to be translated, each candidate domain adapter from the plurality of candidate domain adapters corresponding to at least one domain. The method includes obtaining, based on the target domain adapter corresponding to the information to be translated, a translation result corresponding to the information to be translated.

### CROSS-REFERENCE TO RELATED APPLICATIONS

This application is a by-pass continuation application of International Application No. PCT/KR2023/007944, filed on Jun. 9, 2023, which based on and claims priority to Chinese Patent Application No. 202211243383.6, filed on Oct. 11, 2022, in the Chinese Intellectual Property Office, and Chinese Patent Application No. 202210674929.7, filed on Jun. 14, 2022, in the Chinese Intellectual Property Office, the disclosures of which are incorporated by reference herein in their entireties.

### TECHNICAL FIELD

The present disclosure relates to a technical field of artificial intelligence, machine learning, etc., and in particular, to a machine translation method, devices, and storage medium.

### BACKGROUND

Natural language processing is an important part of artificial intelligence. However, research on natural language processing, and developing applications that utilize natural language processing, are challenging. Research on natural language processing start from a machine translation system through which the likelihood of automated translation of a computer is seen through a large number of scientific experiments, by the general public, and the scientific community.

Neural network machine translation is a machine translation method proposed in recent years, primarily using neural networks, implementing techniques that translate between different languages. In the related art, there are a variety of methods that utilize the neural network machine translation, but still have room for large improvement neural network models. Therefore, improved utilization of neural networks for machine translation is a hot topic in current research.

### SUMMARY

The present disclosure provides a machine translation method, devices, and storage medium, as follows:

According to one or more embodiments, a method performed by an electronic device, comprises acquiring information to be translated.

The method performed by an electronic device, comprises determining, based on the information to be translated, a target domain adapter from a plurality of candidate domain adapters, the target domain adapter corresponding to the information to be translated, each candidate domain adapter from the plurality of candidate domain adapters corresponding to at least one domain.

The method performed by an electronic device, comprises obtaining, based on the target domain adapter corresponding to the information to be translated, a translation result corresponding to the information to be translated.

In another aspect, there is provided an electronic device comprising a memory, a processor, and computer programs stored on the memory, the processor executing the computer programs to implement the methods described above.

In another aspect, a computer readable storage medium is provided having stored thereon a computer program which, when executed by a processor, implements the methods described above.

### BRIEF DESCRIPTION OF THE DRAWINGS

In order to more clearly illustrate the technical solutions in the embodiments of the present disclosure, the accompanying drawings, which are to be used in the description of the embodiments of the present disclosure, are briefly described below.

FIG. 1 is a schematic diagram of an implementation environment of a machine translation method provided by one or more embodiments of the present disclosure;

FIG. 2 is a flow diagram of a method performed by an electronic device provided by one or more embodiments of the present disclosure;

FIG. 3 is a schematic structural diagram of a machine translation model provided by one or more embodiments of the present disclosure;

FIG. 4 is a schematic diagram of a structure of a data distribution prediction module provided by one or more embodiments of the present disclosure;

FIG. 5 is a flowchart of an expert selector execution flow provided by one or more embodiments of the present disclosure;

FIG. 6 is a diagram of a way of constructing a target decoded feature provided by with one or more embodiments of the present disclosure;

FIG. 7 is a schematic structural diagram of a candidate domain adapter provided by one or more embodiments of the present disclosure;

FIG. 8 is a schematic diagram of an execution process of a machine translation model provided by one or more embodiments of the present disclosure;

FIG. 9 is a schematic diagram of an execution process of a machine translation model provided by one or more embodiments of the present disclosure;

FIG. 10 is a schematic diagram of an execution process of a machine translation model provided by one or more embodiments of the present disclosure;

FIG. 11 is an example diagram of a machine translation provided by one or more embodiments of the present disclosure;

FIG. 12 is an example diagram of a machine translation provided by one or more embodiments of the present disclosure;

FIG. 13 is an example diagram of a machine translation provided by one or more embodiments of the present disclosure;

FIG. 14 is a flow diagram of a method performed by an electronic device provided by one or more embodiments of the present disclosure;

FIG. 15 is a schematic structural diagram of a machine translation model provided by one or more embodiments of the present disclosure;

FIG. 16 is an schematic interface diagram of a model maintenance update provided by one or more embodiments of the present disclosure;

FIG. 17 is a schematic structural diagram of a model training apparatus provided by one or more embodiments of the present disclosure;

FIG. 18 is a schematic flow diagram of a method performed by an electronic device provided by one or more embodiments of the present disclosure;

FIG. 19 is a schematic diagram of a data distribution prediction module training process provided by one or more embodiments of the present disclosure;

FIG. 20 is a schematic diagram of a variation curve of a training phase integration function provided by one or more embodiments of the present disclosure;

FIG. 21 is a schematic diagram of a prototype database construction flow provided by one or more embodiments of the present disclosure;

FIG. 22 is a schematic diagram of a mixture expert module training process provided by one or more embodiments of the present disclosure;

FIG. 23 is a schematic diagram of a data distribution prediction module updating process provided by one or more embodiments of the present disclosure;

FIG. 24 is a schematic diagram of a mixture expert module updating process provided by one or more embodiments of the present disclosure;

FIG. 25 is a schematic diagram of a data distribution prediction module updating process provided by one or more embodiments of the present disclosure;

FIG. 26 is a schematic diagram of a prototype database updating process provided by one or more embodiments of the present disclosure;

FIG. 27 is a schematic diagram of a newly added expert module provided by one or more embodiments of the present disclosure;

FIG. 28 is a schematic structural diagram of a machine translation model provided by one or more embodiments of the present disclosure;

FIG. 29 is a schematic structural diagram of an electronic device provided by one or more embodiments of the present disclosure.

### DETAILED DESCRIPTION

Embodiments of the present disclosure are described below in conjunction with the appended drawings. It should be understood that the embodiments set forth below in connection with the appended drawings are exemplary descriptions of the technical solutions used to explain the embodiments of the present disclosure and that the technical solutions to the embodiments of the present disclosure are not limited thereto.

It will be understood by those within the art that the singular forms “a” “an” and “the” may include the plural forms as well, unless expressly stated otherwise. It will be further understood that the terms “comprise” and “include,” when used in the present disclosure, refer to the presence of corresponding features, information, data, steps, operations, but do not preclude the implementation of other features, information, data, steps, operations, etc., as is known in the art.

The present disclosure relates to a field of artificial intelligence technology, which is a theory, method, technique, and application system that simulates, extends, and expands a person's intelligence, perceives environment, acquires knowledge, and uses knowledge to obtain optimal results by using a digital computer or a digital computer-controlled machine. Artificial intelligence is a comprehensive technology of computer science that attempts to understand the nature of intelligence and produces a new intelligent machine that may react in a manner similar to human intelligence.

In particular, the present disclosure may be related to machine learning that specifically studies how a computer simulates or achieves human learning behavior to obtain new knowledge or skills, and reorganizes existing knowledge structures to continually improve its own performance. Machine learning and deep learning typically include techniques such as artificial neural networks, belief networks, reinforcement learning, migration learning, inductive learning, teaching learning, etc. The present disclosure may utilize techniques of artificial intelligence techniques, machine learning, etc., to train a machine translation model, and to provide translation services using machine translation models.

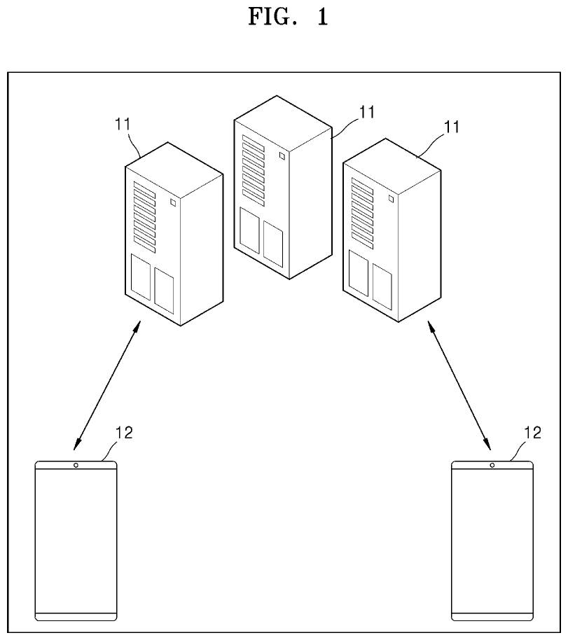

The implementation environment of the present disclosure is described referring to FIG. 1 as an example below.

FIG. 1 is a schematic diagram of an implementation environment of a machine translation method provided by the present disclosure. As shown in FIG. 1, the implementation environment includes an electronic device 11.

In one or more examples, as shown in FIG. 1, a user's terminal 12 may also be included in the implementation environment. The electronic device 11 may send a trained machine translation model to the terminal 12, which uses the machine translation model to provide translation services. In one or more examples, the terminal 12 may output a translation result of the information to be translated by using an offline machine translation model; for example, translating a Chinese language sentence to an English sentence. In one or more examples, the terminal 12 may send a translation request to the electronic device 11; the electronic device 11 receives the translation request sent by the terminal 12, outputs a translation result of the information to be translated by using the trained machine translation model, and returns the translation result to the terminal 12.

The electronic device 11 may use the model training method provided by the present disclosure to train a machine translation model. In one or more examples, the electronic device 11 may be a server that may perform decomposing training on each module in the machine translation model based on a large number of datasets. The machine translation model may include a codec module, a data distribution prediction module, and a mixture expert module. Decomposing training refers to the decomposition of the training process of the machine translation module in terms of individual modules to separate, independent training between the individual modules. In the present disclosure, the server may first train a codec module. Subsequently, the trained codec module is fixed to train the data distribution prediction module. Finally, the trained codec module and the data distribution prediction model are fixed, and the mixture expert module in the machine translation model is trained.

It should be noted that the electronic device 11 and the terminal 12 may be connected by a wired or wireless communication technologies. The electronic device 11 may be a server, which may be a stand-alone physical server, a server cluster or distributed system comprising a plurality of physical servers, and a cloud server or server cluster providing basic cloud computing services such as cloud services, cloud databases, cloud computing, cloud functions, cloud storage, network services, cloud communications, middleware services, domain name services, security services, and big data and artificial intelligence platforms. The terminal may be a smartphone, a smart robot, a tablet computer, a laptop computer, a digital broadcast receiver, a Mobile Internet Device (MID), a personal digital assistant (PDA), a desktop computer, an in-vehicle terminal (e.g., an in-vehicle navigation terminal, a car computer, etc.), a smart speaker, a smart watch, etc.

In order to make the objects, technical solutions, and advantages of the present disclosure more apparent, the embodiments of the present disclosure are described in further detail below in conjunction with the accompanying drawings.

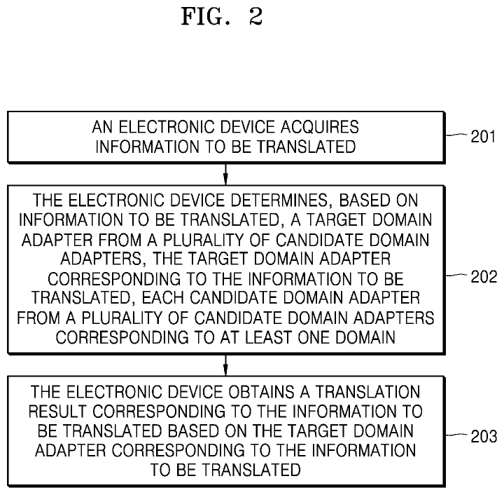

FIG. 2 is a schematic diagram of a machine translation method provided by one or more embodiments of the present disclosure. The method is a method performed by an electronic device, which may be any device known to one of ordinary skill in the art such as a terminal, a server, or a cloud computing central device, which is not limited in the present disclosure. As shown in FIG. 2, the method includes the following operations 201-203.

In operation 201, the electronic device acquires information to be translated.

The information to be translated may be the information of the original language that requires translation. The information of the original language to be translated may be translated to the translation result of the target language by the machine translation method of the present disclosure. For example, one Chinese sentence may be translated to a corresponding English sentence.

The information to be translated may be information of any domain, for example, an IT domain, a medical domain, a legal domain, or any other domain known to one of ordinary skill in the art in which information may be translated. In the present disclosure, domain adapters corresponding to various domains are provided for each domain, and may be translated by using the domain adapter corresponding to the domain of information to be translated. Thus, a suitable target domain adapter may be selected for the information to be translated, and the information to be translated may be translated by using the selected domain adapter by the following operations 202-203. In the present disclosure, the domain adapter may also be referred to as an Expert module.

In operation 202, the electronic device determines, based on information to be translated, a target domain adapter corresponding to the information to be translated from a plurality of candidate domain adapters, where each candidate domain adapter may correspond to at least one domain. The target domain adapter may be determined based on an input such as a speech utterance or text, where one or more words included in the speech utterance or text are analyzed to identify candidate domain adapters.

In operation 203, the electronic device may obtain a translation result corresponding to the information to be translated based on the target domain adapter corresponding to the information to be translated.

In the present disclosure, a correspondence between the candidate domain adapter and each domain may be established. For example, one domain adapter may correspond to one or more domains. Based on this correspondence, when translating information in various domains, there may be a targeted choice of domain adapters corresponding to various domains to translate information from different domains, which may significantly improve the accuracy of the translation.

Each candidate domain adapter may correspond to at least one domain. Each candidate domain adapter may be configured to convert decoded features of information in the corresponding domain of the candidate domain adapter. For example, for information to be translated, the decoded features of the information to be translated may be converted into decoded features that match the domain to which the information to be translated belongs by the target domain adapter.

In the present disclosure, a machine translation model may include an encoder, a decoder, and various candidate domain adapters. Upon translation, the first encoded feature of the information to be translated may be acquired by the encoder; the first encoded feature may be decoded by the decoder, to obtain a decoded feature, the decoded feature may be converted by the target domain adapter, and the corresponding translation result may be obtained by using the converted decoded feature.

In one or more embodiments, a likelihood that each candidate domain adapter is a target domain adapter may be predicted based on a first encoded feature of the information to be translated to select a target domain adapter of the information to be translated. The operation 202 may be performed by the following operations 202_a, 202_b, 202_c, and accordingly, the corresponding operation 203 may be performed by the following sub-operation 203_a:

In operation 202_a, the electronic device acquires a first encoded feature of the information to be translated.

The first encoded feature may be an encoded hidden state vector of the information to be translated. The electronic device may encode the information to be translated by an encoder to obtain the encoded hidden state vector.

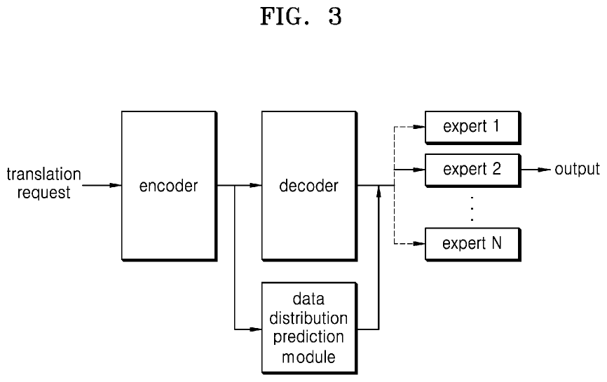

FIG. 3 is a schematic structural diagram of a machine translation model provided by the present disclosure. As shown in FIG. 3, the machine translation model may include an encoder. An electronic device may acquire a sequence of word vectors of the information to be translated by querying a word vector table, and input the word vector sequence to an encoder, perform feature extraction on the information to be translated by an encoder, obtain an encoded hidden state vector of the information to be translated, where the encoded hidden state vector characterizes semantic features of the information to be translated.

For example, the information to be translated maybe a Chinese sentence x including n subwords, and the word vector sequence of the Chinese sentence x is x=(x₁, . . . , xᵢ, . . . , xₙ) by querying the word vector table, xᵢ denotes the word vector of the i^{th} subword among n subwords, for example, xᵢ may be a 512-dimensional vector. The word vector sequence is an n×512-dimensional vector. By converting x into an encoded hidden state vector h=(h₁, . . . , hᵢ, . . . , hₙ), hᵢ denotes the encoded hidden state of the i^{th} subword. For example, hᵢ may be a 256-dimensional vector, 512-dimensional vector, etc., and in the case of the 512-dimensional vector, then h may also be an n×512-dimensional vector.

In operation 202_b: the electronic device determines first indication information of the information to be translated according to the first encoded feature.

The first indication information may characterize the likelihood that each candidate domain adapter is a target domain adapter. For example, the first indication information may include a score that each candidate domain adapter is a target domain adapter. For example, the score may be a probability, score, or any information that may characterize a high or low likelihood (e. g., a higher probability indicates a higher likelihood that the candidate domain adapter is a target domain adapter).

In one or more examples, the first encoded feature includes a feature vector of each word in the word sequence dimension, the electronic device may perform a pooling operation on the first encoded feature in the word sequence dimension of the first encoded feature, and map the first encoded feature after the pooling operation as the first indication information. For example, if the first encoded feature is an encoded hidden state vector h=(h₁, . . . , hᵢ, . . . , hₙ), n indicating that the information to be translated includes n words (e. g., h may be an n×512-dimensional vector), n is the word sequence dimension, h may be converted to a 1×512-dimensional vector by a pooling operation in the word sequence dimension. For example, if there are 12 candidate domain adapters, a 1×512-dimensional encoded hidden state vector may be mapped to a score of the information to be translated at 12 candidate domain adapters by a mapping operation such as a linear mapping or a non-linear mapping.

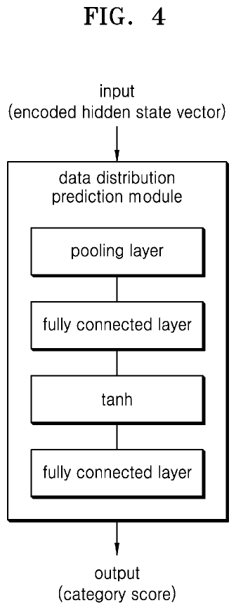

As shown in FIG. 3, the machine translation model may include a data distribution prediction module, and an electronic device may input a first encoded feature (translation request) into a data distribution prediction module to output the first indication information. FIG. 4 is a schematic structural diagram of a data distribution prediction module provided by one or more embodiments of the present disclosure, as shown in FIG. 4, in the data distribution prediction module, the first layer may be a pooling layer, the second layer may be a fully connected layer, the third layer may be a tan h active function layer, and the fourth layer may be a fully connected layer. Taking the first encoded feature as an encoded hidden state vector as an example, the electronic device may input an encoded hidden state vector h into a data distribution prediction module, in the pooling layer, by the following Equation 1, and perform a pooling operation on the encoded hidden state vector h in a word sequence dimension by using the pooling function Pooling( ) to compress word sequence dimensions of the encoded hidden state vector:

\hat{h}=Pooling(h); Equation 1:

Where h denotes the encoded hidden state vector, h denotes the encoded hidden state vector after the pooling operation. For example, h may be an n×512-dimensional vector, after the pooling operation, the word sequence dimension is reduced from n to 1 to obtain a 1×512-dimensional vector ĥ.

The encoded hidden state vector output by the first layer may then be sequentially passed through the second layer, the third layer, and the fourth layer, each layer processing the output of the upper layer, for example, linearly changing h at the second layer and outputting a result; non-linearly changing the output of the second layer by the tan h active function at the third layer, and outputting a result; and linearly changing the output of the third layer at the fourth layer, and outputting a result. The first indication information may be obtained based on the output of the fourth layer. In one or more examples, from the second layer to the fourth layer, h may be processed by the following Equation 2, to obtain a final score:

l^{D}=tan h(ĥW₁^{D}+b₁^{D})W₂^{D}+b₂^{D}; Equation 2:

Where, l^{D} is the first indication information (e. g., the first indication information may be a first score vector of the sentence level corresponding to the whole sentence). W₁^{D} and bf are linear change parameters of the second layer, and W₂^{D} and b₂^{D} are linear change parameters of the fourth layer. In one or more examples, W₁^{D} may be a 512×512 matrix, b₁^{D} may be a 1×512-dimensional vector, a 1×512-dimensional vector ĥ passes W₁^{D} and b₁^{D}, and after a linear change, a 1×512-dimensional vector may be obtained. The 1×512-dimensional vector may then be processed through the tan h active function of the third layer; and the activated 1×512-dimensional vector is input to the fourth layer. W₂^{D} is a matrix of 512×12 dimensions, b₂^{D} is a 1×12-dimension vector, the activated 1×512-dimensional vector passes through W₂^{D} and b₁^{D} and after a linear change, a 1×12-dimensional score vector l^{D} may be obtained, where l^{D} includes scores of the information to be translated at 12 candidate domain adapters.

In operation 202_c, the electronic device determines, from the plurality of candidate domain adapters, a target domain adapter corresponding to the information to be translated according to the first indication information.

In operation 203_a, the electronic device decodes the first encoded feature to obtain a decoded feature, convert the decoded feature based on the target domain adapter corresponding to the information to be translated, and may obtain a translation result corresponding to the information to be translated based on the converted decoded feature.

In one or more examples, the electronic device may, based on the first indication information, use the candidate domain adapter with the highest likelihood as the target domain adapter.

The first indication information may be a preliminary domain judgment based on the information to be translated as a whole, and may be considered as a judgment of the sentence level. For example, the first indication information may be a first score vector of the sentence level (e.g., the encoded hidden state vector of the whole sentence output by the encoder is input to the data distribution prediction module). The first score vector of the sentence level corresponding to the whole sentence is output through the data distribution prediction module, the candidate domain adapter with the highest score may be used as the target domain adapter corresponding to the whole sentence at the sentence level.

The decoded features may be decoded hidden state vectors (e.g., inputting the encoded hidden state vector output by the encoder into the decoder), decoding the encoded hidden state vector by a decoder, to obtain a decoded hidden state vector.

In one or more examples, the decoder comprises at least two decoding levels, each decoding level corresponding to a respective plurality of candidate domain adapters. The first indication information may characterize the likelihood that each candidate domain adapter is a target domain adapter corresponding to the information to be translated at the respective decoding level. In one or more examples, operation 202c may include: the electronic device determines, according to the first indication information, from each candidate adapter corresponding to each decoding level, the target domain adapter corresponding to the information to be translated at the respective decoding level. Accordingly, one possible implementation of operation 203 may include, for each decoding level, converting, according to the decoded feature of the information to be translated, at a respective decoding level and via the target domain adapter corresponding to the information to be translated at the respective decoding level to obtain the converted decoded feature, and outputting the converted decoded feature; and outputting, according to the converted decoded features output by the last decoding level, a translation result of the information to be translated.

In one or more examples, each decoding level may correspond to a respective group of adapters, and each candidate domain adapter included in the group of adapters may cover each domain. For example, there are a total of 6 domains: domain A, domain B, domain C, domain D, domain E, domain F; each group of candidate domain adapters has four candidate domain adapters. In the four candidate domain adapters at the first decoding level: the first adapter may correspond to the domains A and B, the second adapter may correspond to the domains C and E, the third adapter may correspond to the domain D, and the fourth adapter may correspond to the domain F. In the four candidate domain adapters at the second decoding level, : the first adapter may correspond to the domains A and B, the second adapter may correspond to the domains C and E, the third adapter may correspond to the domain D, and the fourth adapter may correspond to the domain F. The network parameters between the first adapter at the first decoding level and the first adapter at the second decoding level may be different (e.g., they are two different adapters). The methods of the present disclosure are not limited by the numerical size or correspondence in the examples set forth above, and in one or more examples, the correspondence between the domain and each group of adapters, the number of domains, the number of adapters corresponding to each decoding level, etc., may be configured based on the needs, and the present disclosure is not limited in this respect. For example, the method of the present disclosure may support an order of magnitude of the total number of domains, an order of magnitude of the total number of adapters may be on the order of magnitude of ten, hundreds, or more, etc.

In one or more embodiments, the present disclosure contemplates a technical idea of selecting a corresponding target domain adapter for each target segment; each target segment is a segment in which the information to be translated correspond to a target language, which may be, but is not limited to word (token). That is, the target domain adapter of the information to be translated includes a target domain adapter of each target segment corresponding to the information to be translated. The decoded features of the information to be translated may include a segment decoded feature of each target segment. A target domain adapter of each target segment may be used for converting the segment decoded features of the target segment. In one or more examples, operation 202 may be implemented by the following operations 202_d to 202_e, and operation 203 may be implemented by the following operation 203_b.

In operation 202_d, the electronic device acquires a first encoded feature of the information to be translated.

In this operation, the first encoded feature may be acquired in the same manner as operation 202_a, as described above.

In operation 202_e, the electronic device, based on the first encoded feature, may obtain a segment decoded feature of each target segment corresponding to the information to be translated, and may obtain second indication information of the target segment based on the segment decoded feature of each target segment, and may determine a target domain adapter of the target segment based on the second indication information of the target segment.

In operation 203_b, for each target segment, the electronic device, based on the segment decoded feature of the target segment and by the target domain adapter corresponding to the target segment, may output a translation result of the target segment.

Where the second indication information of each target segment may characterize the likelihood that each candidate domain adapter is a target domain adapter of the target segment. The second indication information of the target segment may include a score that each candidate domain adapter is a target domain adapter of the target segment; the score may be a similarity, a probability, a score, or any information that may characterize a high or low probability. For each target segment, the electronic device may, based on the second indication information of the target segment, use the candidate domain adapter with the highest likelihood as the target domain adapter of the target segment.

The decoder may include at least one decoding level, and in this operation, the electronic device may determine a target domain adapter corresponding to the target segment at each decoding level. A target domain adapter of the target segment at each decoding level may be used to convert the segment decoded feature of the target segment at the respective decoding level.

The corresponding processing flows of the respective decoding levels are described first below.

In one or more examples, the electronic device, based on a segment decoded feature of the target segment and by a target domain adapter corresponding to the target segment, may output a translation result of the target segment, including: for each decoding level, converting, according to the segment decoded feature of the target segment at the respective decoding level and via a target domain adapter corresponding to the target segment at the respective decoding level to obtain a converted segment decoded feature, and outputting the converted segment decoded feature; and outputting the translation result of the target segment according to the converted segment decoded feature of the last decoding level.

The segment decoded features of the target segment at each decoding level may be obtained by decoding the first encoded feature and the output result of the target segment at the previous decoding level. In one or more examples, for each target segment, the segment decoded features of the target segment at each decoding level are acquired by:
for a first decoding level, obtaining a segment decoded feature of the target segment at the first decoding level, based on the first encoded feature and a second encoded feature of a translated segment prior to the target segment;
for a second decoding level, obtaining a segment decoded feature of the target segment at the second decoding level, based on the first encoded feature and a converted segment decoded feature outputted by the target segment at the previous decoding level;
where the first decoding level is a first decoding level of at least two decoding levels, and the second decoding level is any decoding level other than the first decoding level.

The translated segments may refer to segments that have an output translation result before the target segment. Upon translation, each target segment may be sequentially output in a position sequence of each target segment, where the position sequence may refer to the sequential order of the output (e.g., there are a total of 3 English words to be output). An English word “happy” with a position sequence of 1 may be output first, an English word “new” with a position sequence of 2 may be output second, and an English word “year” with a position sequence of 3 may be output third.

For the segment of the i^{th} translation result to be output, the first encoded feature and the second encoded feature of the first (i−1)^{th} segments of the previous output translation result may be input into the first decoding level, to obtain the segment decoded features of the i^{th} segment at the first decoding level. For example, when a Chinese sentence is translated to an English sentence, for the itch English segment to be output, a translation result of the i^{th} English segment may be output in combination with a second encoded feature of the first (i−1)^{th} English segments that have been previously outputted; where feature extraction may be performed on the first (i−1)^{th} English segment which have been output to obtain the second encoded feature.

How to determine a target domain adapter for each decoding level is described below.

The electronic device may determine, based on the segment decoded feature of the target segment at the at least one decoding level, a target domain adapter corresponding to the target segment at the respective decoding level. In one or more examples, a segment decoded feature of one decoding level may be utilized to predict the target domain adapter corresponding to the target segment at each level, and accordingly the implementation of operation 202_e may include operation 202_e-1. In one or more examples, the segment decoded feature of each decoding level may be utilized to predict the target domain adapter corresponding to the target segment at the respective decoding level, and accordingly the implementation of operation 202e may include operation 202_e-2.

In operation 202_e-1, for each target segment, the electronic device determines, based on the segment decoded feature of the target segment at the first decoding level, second indication information of the target segment; the electronic device determines, based on the second indication information corresponding to the target segment at the first decoding level, a target domain adapter corresponding to the target segment at the respective decoding level.

The second indication information of the target segment at the first decoding level may characterize the likelihood that each candidate domain adapter is a target domain adapter corresponding to the target segment at each decoding level. The electronic device may utilize the second indication information to determine a target domain adapter corresponding to the target segment at each decoding level.

In one or more examples, each decoding level may correspond to a respective plurality of candidate domain adapters, and the electronic device may determine, based on the second indication information of the target segment at the first decoding level, a target domain adapter corresponding to the target segment at each decoding level from a plurality of candidate domain adapters corresponding to each decoding level.

For example, each layer may correspond to 12 candidate domain adapters: the first domain adapter of each layer may correspond to the law domain and the medical domain; the second domain adapter of each layer may correspond to the IT domain; ⋅ ⋅ ⋅ ⋅ ⋅ ⋅ the twelfth domain adapter of each layer may correspond to the artificial intelligence domain; the second indication information may be a 1×12 second score vector, which may include 12 scores, and the highest score may correspond to an adapter corresponding to the artificial intelligence domain. Then, in each layer, the twelfth domain adapter of 12 candidate domain adapters corresponding to this layer may be used as the target domain adapter of the target segment at this layer.

In one or more examples, if the decoder includes a total of three layers, each layer corresponding to 12 candidate domain adapters, there are a total of 36 candidate domain adapters, the second indication information may also be a 3×12 second score vector, may include 36 scores, where 12 scores for each row represent scores for 12 candidate domain adapters for the corresponding layer. For example, based on the highest score for row 1, it may be determined that the target domain adapter of the target segment at the first layer is the second candidate domain adapter in the 12 candidate domain adapters of the first layer; based on the highest score of row 2, it may be determined that the target domain adapter of the target segment at the second layer is the fifth candidate domain adapter in the 12 candidate domain adapters of the second layer.

In operation 202_e-2, for each target segment, according to the segment decoded feature of the target segment at each decoding level, determining second indication information corresponding to the target segment at the respective decoding level, and determining, according to the second indication information corresponding to the target segment at the respective decoding level, a target domain adapter corresponding to the target segment at the respective decoding level.

The second indication information of the target segment at the respective decoding level may characterize the likelihood that the respective candidate domain adapter is a target domain adapter corresponding to the target segment at the respective decoding level. For example, for each decoding level, second indication information corresponding to the target segment at the decoding level may be obtained based on a similarity between a segment decoded feature of the target segment at the decoding level and a domain feature vector of each candidate domain adapter of the decoding level.

In one or more examples, if each decoding level may correspond to a respective plurality of candidate domain adapters, the determining the implementation of the target domain adapter in the manner 2 may include: for each decoding level, the electronic device determining, according to the second indication information of the target segment at the respective decoding level, a target domain adapter corresponding to the target segment at the respective decoding level from the respective candidate adapters corresponding to the respective decoding level.

For example, each layer may correspond to 12 candidate domain adapters: the second indication information of each layer may be a 1×12 second score vector, which may include 12 scores. For the first layer, the twelfth domain adapter with the highest score in the second score vector of the first layer is selected; for the second layer, the third domain adapter with the highest score in the second score vector of the second layer is selected.

Determination of the second indication information is described below:

In the present disclosure, each candidate domain adapter may correspond to a domain feature vector. In one or more examples, the likelihood that a candidate domain adapter is a target domain adapter of the target segment may be predicted by the domain feature vector of the candidate domain adapter. In one or more examples, for each target segment, the likelihood that each candidate domain adapter is a target domain adapter is predicted in conjunction with the segment decoded feature of the translated segment prior to the target segment. Accordingly, the manner in which the second indication information may be acquired may include the following manners 1 and 2.

Manner 1: For each target segment, the electronic device may obtain the second indication information based on the similarity between the segment decoded feature of the target segment and the domain feature vector of each candidate domain adapter.

For example, a similarity between a segment decoded feature and each domain feature vector may be used as a score that the corresponding candidate domain adapter is the target domain adapter of the target segment.

If operation 202_e is implemented by operation 202_e-1, in manner 1, the segment decoded feature of the target segment is the segment decoded feature of the target segment at the first decoding level.

If operation 202_e is implemented by operation 202_e-2, in manner 1, the segment decoded feature of the target segment is the segment decoded feature of the target segment at each decoding level. That is, for each decoding level, the electronic device may obtain the second indication information of the target segment at the decoding level based on the similarity between the segment decoded feature of the target segment at the decoding level and the domain feature vector of each candidate domain adapter.

Manner 2. For each target segment, the second indication information of the target segment is determined, based on a segment decoded feature of the target segment, and a segment decoded feature of the translated segment prior to the target segment.

If operation 202_e is implemented by operation 202_e-1, in manner 2, the segment decoded feature of the target segment is the segment decoded feature of the target segment at the first decoding level. The segment decoded feature of the translated segment is the segment decoded feature of the translated segment at the first decoding level.

If operation 202_e is implemented by operation 202_e-2, in manner 2, the segment decoded feature of the target segment is the segment decoded feature of the target segment at each decoding level. The segment decoded feature of the translated segment is the segment decoded feature of the translated segment at the first decoding level. That is, for each decoding level, the electronic device determines the second indication information of the target segment at the decoding level based on the segment decoded feature of the target segment at the decoding level, and a segment decoded feature of the translated segment at the decoding level. For example, for the i^{th} English segment to be output, the second indication information of the i^{th} English segment at the third layer may be obtained based on the segment decoded feature of the i^{th} English segment at the third layer, and the segment decoded features of the first (i−1)^{th} English segments at the third layer.

The electronic device may also determine the second indication information of the target segment in conjunction with the manners 1 and 2 described above. In one or more examples manner in which the second indication information is determined in connection with manners 1 and 2 comprises the following operations S1-S3:

In operation S1, for each target segment, the electronic device may acquire a third weight corresponding to a segment decoded feature of the target segment, and a fourth weight corresponding to a segment decoded feature of the translated segment prior to the target segment;

In operation S2, weighting the segment decoded feature of the target segment and the segment decoded feature of the translated segment prior to the target segment based on the third weight and the fourth weight to obtain a target decoded feature;

In operation S3, obtaining the second indication information based on the similarity between the target decoded feature and the domain feature vector of each candidate domain adapter.

In one or more examples, the target domain adapter of the target segment may also be determined in conjunction with the first indication information and the second indication information. In one or more examples, the implementation of operation 202 may include operation 202_d, operation 202_b, and operation 202_e, where in operation 202_e, the operation of determining the target domain adapter of the target segment based on the second indication information of the target segment includes: for each target segment, determining the target domain adapter of the target segment based on the first indication information and the second indication information of the target segment. In one or more examples, the target domain adapter of the target segment may be determined by using the integrated indication information by integrating the first indication information and the second indication information. In one or more examples, the manner in which the target domain adapter is determined based on the first indication information and the second indication information may be implemented by the following operations S4 to S6:

In operation S4, acquiring a first weight corresponding to the first indication information and a second weight corresponding to the second indication information;

In operation S5, weighting the first indication information and the second indication information based on the first weight and the second weight to obtain the third indication information;

In operation S6: determining the target domain adapter of the target segment based on the third indication information.

In one or more examples, in operation S4, the acquiring of the first weight and the second weight includes: for each target segment, determining the second weight based on the position sequence of the target segment in the respective target segment, and obtaining the first weight based on the second weight; where the second weight corresponding to one target segment is positively correlated to the position sequence.

The third indication information may characterize the likelihood that each candidate domain adapter is a target domain adapter of the target segment. For example, the third indication information may be a third score vector that includes a score of each candidate domain adapter. The electronic device may use the candidate domain adapter with the highest likelihood is a target domain adapter.

In one or more examples, determining the target domain adapter corresponding to the target segment may be based on a domain judgement of the target segment, which may be a more fine-grained judgement than the domain judgement of the information to be translated as a whole. For example, if a Chinese sentence is translated to a corresponding English sentence, the target segment may be an English segment corresponding to a Chinese sentence translated into English (e.g., the English segment may include at least one English word). By determining the domain adapter corresponding to the English segment, a domain judgement that may be considered as a word level of domain judgement, for example, for a certain English word, based on the second score vector of the word level corresponding to the English word, a target domain adapter of the word level corresponding to the word may be obtained.

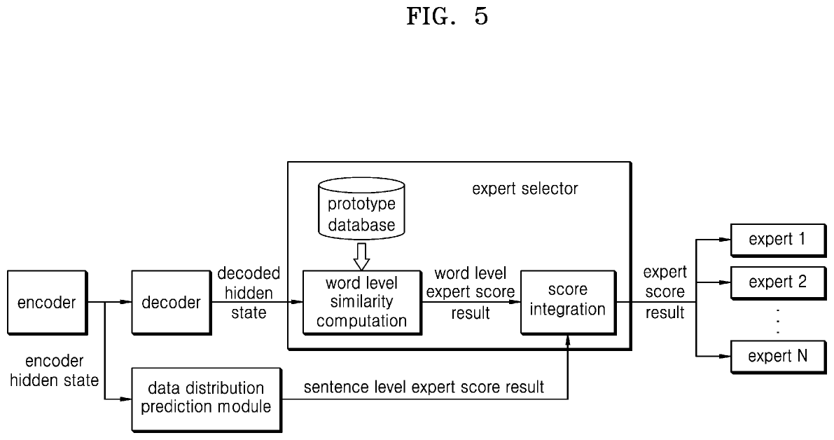

In one or more examples, as shown in FIG. 5, the machine translation model may include an expert selector and various expert modules (e.g., expert 1, expert 2, . . . expert N). The domain adapter may be implemented by an expert module (e.g., one domain adapter may correspond to one expert module (e.g., any one of expert 1, expert 2, . . . and expert N). A determination process of the target domain adapter of the target segment may be achieved by the expert selector. For example, a first score vector of the sentence level (e.g., the sentence level expert score result in FIG. 5) may be determined by the data distribution prediction module. A second score vector of the word level (e.g., the word level expert score result in FIG. 5) may be determined by the expert selector utilizing a prototype database and a word level similarity computation, and a final word-level expert score vector (e.g., corresponding to the expert score result in FIG. 5) may be obtained based on the first score vector of the sentence level and the second score vector of the word level.

In one or more examples, the first indication information may be expressed as: Pₛ(Ept|Eₒᵤₜ), where, Eₒᵤₜ denotes the encoded hidden state vector of the information to be translated, Ept denotes the candidate domain adapter, for example, Ept=1, which denotes the first candidate domain adapter. Pₛ(Ept=1|Eₒᵤₜ) denotes the score of the first candidate domain adapter obtained based on the decoded hidden state vector.

The following is an example of how the second indication information may be obtained, using Equation 3 as an illustration:

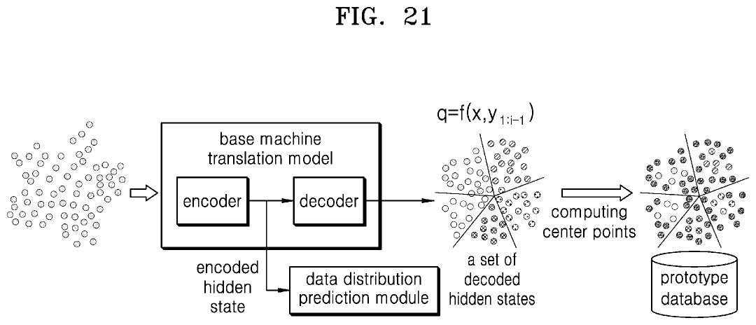

For each target segment, the electronic device may determine a similarity between the target decoded feature of the target segment and the domain feature vector of each candidate domain adapter by the following Equation 3, to obtain the second indication information of the target segment:

$${P}_{t} = Sim ( [ {H}_{o u t , 1 \sim i} ] , {DS}_{k} ) \approx {max}_{j} \{ Sim ( {H}_{o u t , 1 \sim i} , f [ {y}_{o u t}^{kj} ] ) \vert ( {x}^{kj} , {y}^{kj} ) ∈ {DS}_{k} \} ; \qquad Equation 3$$

Where Pₜ denotes the second indication information. The second indication information may be a second score vector, including a score of each candidate domain adapter. DSₖ denotes the domain feature vector of the k^{th} candidate domain adapter. f[yₒᵤₜ^{kj}] refers to the j^{th} domain feature vector of the plurality of domain feature vectors of the k^{th} candidate domain adapter. H_{out,1˜i} denotes the target decoded hidden state of the i^{th} target segment. (x^{kj}, y^{kj}) denotes the j^{th} hidden state center point of the plurality of hidden state center points of the k^{th} candidate domain adapter, x and y denotes a data source employed in computing of the j^{th} hidden state center point (e.g., x representing a Chinese sentence, y representing each English segment in the English parallel sentence corresponding to the Chinese sentence). When computing the hidden state center point, the segment decoded feature of each English segment (e. g., decoded hidden state center point), may be used, as described with respect to the subsequent flow of the prototype database construction corresponding to FIG. 21. Referring to English parallel sentence may mean that, in the model training phase, the training may be performed with a parallel corpus, which is a bilingual or multilingual corpus composed of the original text and its parallel counterpart in the translation text. In one or more example, the English parallel sentences are a parallel corpus of the Chinese sentences.

Sim([H_{out,1˜i}], DSₖ) denotes the similarity between the target decoded hidden state and the k^{th} candidate domain adapter.

In example 1, in Equation 3, for the i^{th} target segment, the similarity may be calculated by directly using the decoded hidden state vector of the i^{th} target segment (i.e., in Equation 3, H_{out,1˜i}=H_{out,i}).

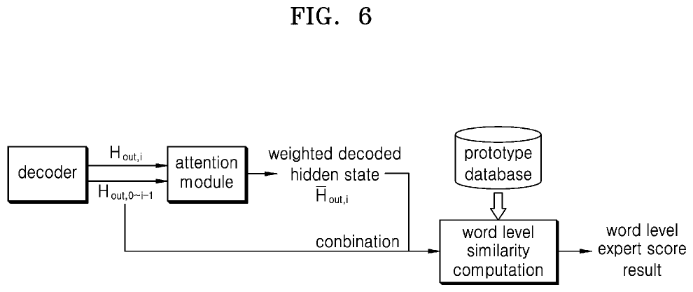

In example 2, in Equation 3, for the i^{th} target segment, the decoded hidden state vector H_{out,i} of the i^{th} target segment and the decoded hidden state vector H_{out,0˜i-1} of the first (i−1)^{th} target segments previously outputted may be utilized to obtain a target decoded hidden state vector H_{out,1˜i}. This acquisition process of the H_{out,1˜i} is described below in the process of FIG. 6:

FIG. 6 is a schematic diagram of a processing flow corresponding to an expert selector. As shown in FIG. 6, the electronic device may utilize an attention model to obtain a weighted decoded hidden state H̅_{out,i} according to the decoded hidden state vector H_{out,i} of the i^{th} target segment and in combination with the decoded hidden state vector H_{out,0˜i-1} of the translated first (i−1)^{th} target segments. The weighted decoded hidden state H̅_{out,i} is then combined with the decoded hidden state H_{out,0˜i-1} of the previous operation, to obtain a target decoded hidden state vector H_{out,1˜i}, and the target decoded hidden state vector H_{out,1˜i} is input to the expert selector (e.g., target decoded hidden state vector is input into word level similarity computation), to obtain a word-level expert score result. The combination operation may be utilized to perform a pooling operation on the H̅_{out,i} and H_{out,0˜i-1}, may also be utilized to perform a tiling operation on the H̅_{out,i} and H_{out,0˜i-1}, or any other suitable operation known to one of ordinary skill in the art. By using the attention mechanism to obtain the weighted decoded hidden state vector, and combining the weighted decoded hidden state vector with the decoded hidden state vector of the translated segment, the target decoded hidden state vector may be obtained such that the target decoded hidden state vector is more able to focus on the most relevant previous target segment (e.g., the English word that has been translated and output before).

In one or more examples, one candidate domain adapter may correspond to at least one domain feature vector. For each candidate domain adapter, if the candidate domain adapter may correspond to a plurality of domain feature vectors, the electronic device may calculate a similarity between the target decoded feature and each domain feature vector of the candidate domain adapter, respectively, to obtain a plurality of similarities, and the largest similarity of the plurality of similarities is the similarity between the target segment and the candidate domain adapter. For example, the electronic device may calculate the similarity of the i^{th} target segment and each domain feature vectors of the k^{th} candidate domain adapter; where if the similarity of the i^{th} target segment and the j^{th} domain feature vector of the k^{th} candidate domain adapter is the largest; then the value of the similarity of the i^{th} target segment and the k^{th} candidate domain adapter is the similarity of the i^{th} target segment and the j^{th} domain feature vector of the k^{th} candidate domain adapter. In the present disclosure, in one or more examples, a prototype database including domain feature vectors of each candidate domain adapter may be pre-built, for example, a candidate domain adapter may be implemented by an expert module, the domain feature vector may be represented as a hidden state center point, the prototype database may include a hidden state center point of each expert module, and one expert module may correspond to at least one hidden state center point.

In one or more examples, as exemplified below in Equation 4, the manner in which the third indication information may be obtained based on the first indication information and the second indication information is illustrated:

In one or more examples, for the implementation of operations S4 and S5, the electronic device may obtain the third indication information based on the first indication information and the second indication information by the following Equation 4:

$${P}_{{w}_{i}} = ( 1 - \frac{t}{T} ) {P}_{s} + \frac{t}{T} {P}_{t} ; \qquad Equation 4$$

Where, P_{w}_{ᵢ} denotes the third indication information corresponding to the target segment wᵢ. The third indication information may be a third score vector, including a score that the target segment wᵢ may correspond to the at least one candidate domain adapter, which is a score of the word level. Pₛ represents the first indication information, which may be a score of the sentence level. Pₜ represents the second indication information, which may be a score of the word level.

For example, the word-level score of the target segment wᵢ in the k^{th} candidate domain adapter may be expressed as: Pₜ=Sim([H_{out,1˜i}], DSₖ); the sentence-level score of the target segment wᵢ in the k^{th} candidate domain adapter may be expressed as: Pₛ(Ept=k|Eₒᵤₜ). The parameter t represents the position sequence of the target segment, and T represents the total number of individual target segments.

When t=0 (e.g., for the first target segment), the value of the third indication information is the same as the first indication information (e.g., the first score vector of the sentence level). At this time, the target domain adapter of the first target segment may be determined directly by using the first indication information. The target domain adapter may be the domain adapter of the sentence level. When t=T (e.g., for the last target segment), the value of the third indication information is the same as the first indication information (e.g., the second score vector of the word level). When 0<t<T, the sentence level score vector and the word level score vector may be considered simultaneously as the final third score vector.

Referring to the schematic flow diagram corresponding to the expert selector as shown in FIG. 6, where the expert selector stores a prototype database, a similarity computation of the word-level expert module based on the hidden state center points of the respective candidate domain adapters in the prototype database may be performed. For example, the translated segment may be combined with the decoded hidden state of the current target segment to characterize the target decoded hidden state, such that the target decoded hidden state may include the context features of the target segment currently to be translated. The similarity computation of the word-level expert module by using the target decoded hidden state helps to improve the accuracy of the most relevant candidate domain adapter of the determined target segment. The first score vector and the second score vector may be subsequently combined. For example, in the manner of linear interpolation, the word-level candidate domain adapter score and the sentence level candidate domain adapter score are combined, which may be based on the dynamic interpolation factor of the decoding location, ultimately a word-level candidate domain adapter may be obtained, for example, the word-level expert module corresponding to the i^{th} word to be translated and output.

A process flow corresponding to a target domain adapter is described below by the following example:

In one or more examples, the processing corresponding to the target domain adapter includes: for each decoding level, normalizing the decoded hidden state vector of the target segment at the decoding level by the target domain adapter corresponding to the target segment at this decoding level, and performing a linear or non-linear transformation processing on the normalized decoded hidden state vector to obtain the converted decoded hidden state vector.

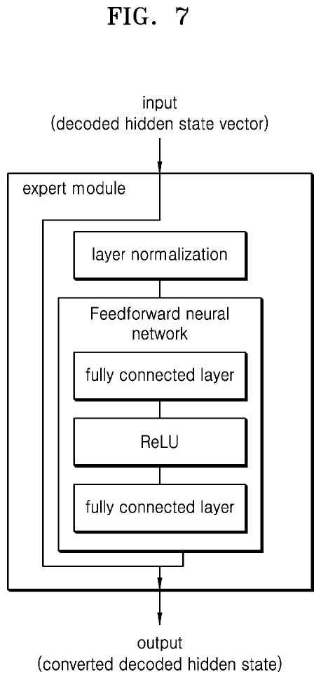

For example, as an example of a transformation process flow corresponding to the execution of the target domain adapter by an expert module, FIG. 7 is a schematic structural diagram of an expert module provided by one or more embodiments of the present disclosure. As shown in FIG. 7, the expert module may include a layer normalization and a feedforward neural network. Upon layer normalization, for the decoded hidden state vector zᵢ of the i^{th} layer of the decoder, the electronic device may normalize the decoded hidden state vector zᵢ input to the target expert module based on the layer normalization function LN( ) by the following equation:

[symbol]

=LN(zᵢ); Equation 5:

Where, [symbol] represents the normalized decoded hidden state vector. i represents the i^{th} decoding level in the decoder, zᵢ represents the decoded hidden state vector of the i^{th} decoding level. For example, zᵢ may be a 1×512 vector. After normalizing zᵢ by the target expert module, each value in the 1×512 vector zᵢ may be converted to values belonging to (0, 1), to obtain a 1×512 vector [symbol] .

For the feedforward neural network, the electronic device may transform the normalized decoded hidden state vector output by the upper layer through the following Equations 6 and 7, using Feed-Forward Networks (FFN), and fuse the transformed decoded hidden state vector with zᵢ:

oᵢ=FFN( [symbol] )+zᵢ; Equation 6:

Where the feedforward neural network FFN( ) is spread out as follows:

FFN( [symbol] )=relu( [symbol] W₁^{E}+b₁^{E})W₂^{E}+b₂^{E}; Equation 7:

Where oᵢ represents the decoded hidden state vector obtained by transforming and fusing the normalized decoded hidden state vector, zᵢ represents the decoded hidden state vector of the i^{th} decoding level, which is the decoded hidden state vector input to the target expert module. FFN( [symbol] ) represents the processing of the normalized vectors [symbol] through the feedforward neural network, the process of which is shown in Equation 7. In the feedforward neural network, as shown in FIG. 7 according to one or more examples, in the feedforward neural network, the first layer is a fully connected layer, the second layer is a linear modification unit (ReLU) active function layer, and the third layer is a fully connected layer. W₁^{E} and b₁^{E} are the linear transformation parameters of the first layer in the feedforward neural network, and W₂^{E} and b₂^{E} are the linear transformation parameters of the third layer in the feedforward neural network, ReLU represents the activation processing on the linear-transformed vector [symbol] by using the W₁^{E} and b₁^{E}. The activated vector may then be further linearly transformed by using W₂^{E} and b₂^{E} to output the decoded hidden state vector after the transformation process.

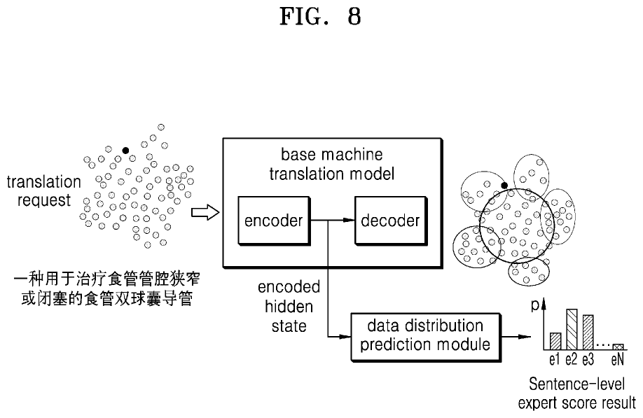

For example, as shown in FIG. 8, if a sentence level expert module may be used, the corresponding translation procedure may include: Operation 1, first converting the Chinese sentence to be translated into the encoded hidden state vector by using the encoder. Operation 2, based on the encoded hidden state vector, predicting, by an independently trained data distribution prediction module other than the decoder, a data distribution category to which the translation request belongs, to obtain a first score vector of the sentence level. Operation 3.1, based on the first score vector, utilizing the sentence level expert module corresponding thereto to obtain a translation result of the whole sentence. For a translation request, “ [symbol] [symbol] [symbol] (An esophageal double balloon catheter for the treatment of esophageal stenosis or stricture)”, an encoder of a base machine translation model may be first utilized to encode it into the encoded hidden state. A base machine translation module may include a trained encoder and a trained decoder. Subsequently, a sentence level expert module may be selected by a data distribution prediction module to obtain a sentence level expert score vector of the translation request by using the sentence level expert module (the sentence level expert score result in the corresponding figure).

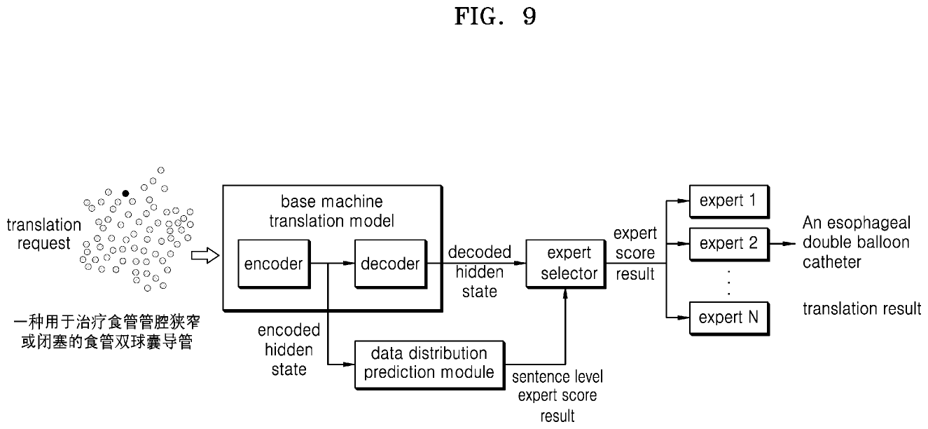

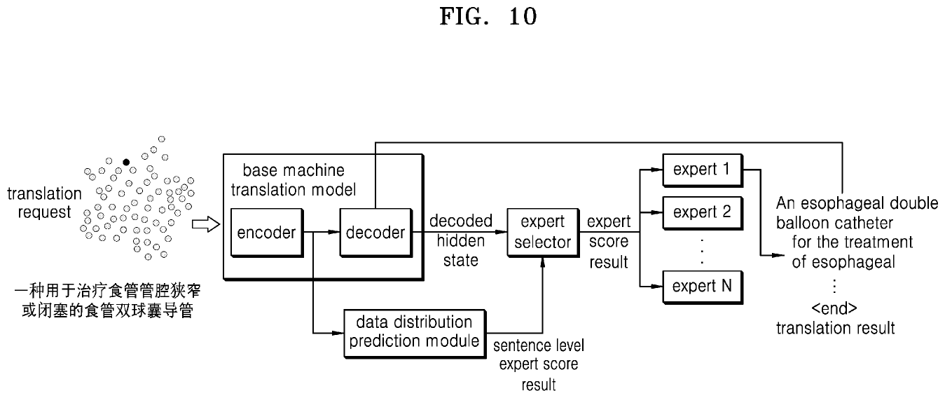

In one or more examples, as shown in FIG. 9, if a word level expert module is used, the corresponding translation flow may include: after obtaining the prediction result of the data distribution prediction module through operation 2, performing operation 3.2 for the i^{th} English word of the translation result output sequence, calculating a word-level expert score vector by using the expert selector, and selecting the corresponding word-level expert module to process the decoded hidden state of the translation request according to the word-level expert score vector, to obtain the i^{th} English word of the output sequence, as shown in FIG. 9. As an example, the expert selected when generating the i^{th} word is ‘expert2’ and the i^{th} word generated is ‘catheter’. Subsequently, operation 4 is performed, operation 3.2 is cyclically performed until the final output is obtained, as shown in FIG. 10. When executed to the j^{th} operation, the selected expert is ‘expert 1’, the corresponding j^{th} word generated is ‘esophageal’, and the encoded features of the j^{th} word is input to the decoder to continue predicting the next word in conjunction with the j^{th} word. In this process, the word-level expert selector may switch the word-level expert module used by the next word according to the decoded hidden state of the next word.

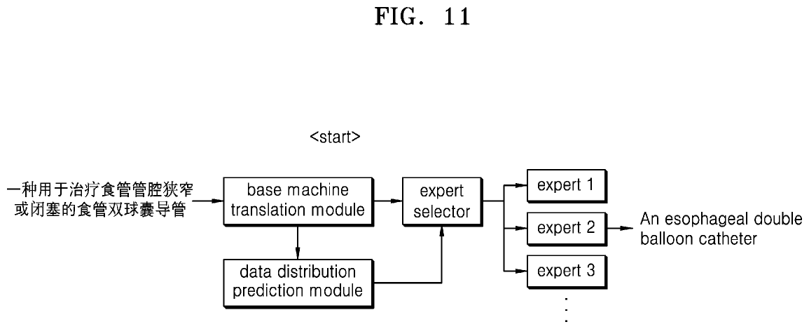

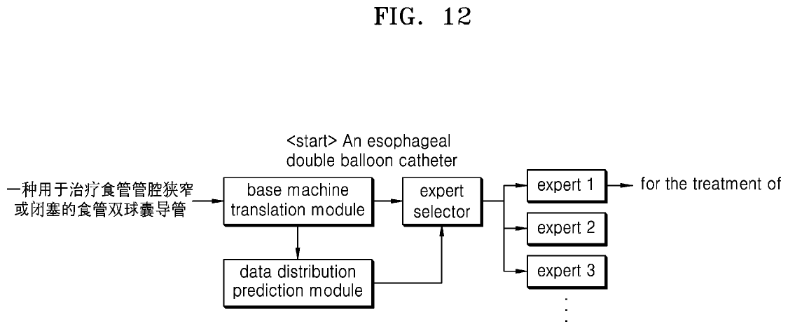

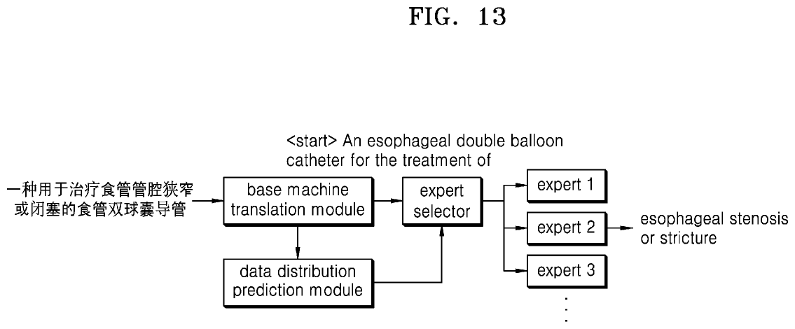

For example, the translation process may be an autoregressive process (e.g., the content to be translated of the i^{th} operation may be predicted by using the target segment that have been translated and output in the first (i−1)^{th} operations). For example, taking the flow of selecting the word level expert module shown in FIGS. 11, 12, and 13, as an example, the process of translating the Chinese sentence “ [symbol] [symbol] [symbol] [symbol] (An esophageal double balloon catheter for the treatment of esophageal stenosis or stricture)” into an English sentence is described below in conjunction with the base machine translation module (Base NMT Module), the data distribution prediction module (Discriminator Module), and the Expert selector in FIGS. 11, 12, and 13. The self-regression-based translation process may begin with a <start> tag, ends with a <end> tag; where a “token” (word) is the smallest element of the input or translation result output sequence. For example, if the sentence is split by a space, ‘token’ may correspond to ‘word’ in the sentence. As shown in FIG. 11, the sentence begins with the <start> tag, and by using the expert 2, translation “An double-balloon catheter” ( [symbol] ) is output. As shown in FIG. 12, by using the <start> tag and “An double-balloon catheter” of the previous operations, by using the expert 1, “for the treatment of” ( [symbol] ) is output. As shown in FIG. 13, by using the <start> tag and “An esophageal double balloon catheter for the treatment of” of the previous operations, by using the expert 2, the “esophageal stenosis or stricture” ( [symbol] ) is output. A final translation result may be obtained based on the above: An esophageal double balloon catheter for the treatment of esophageal stenosis or stricture.

The method of the present disclosure acquires information to be translated, determines, based on the information to be translated, a target domain adapter corresponding to the information to be translated from a plurality of candidate domain adapters, obtains a translation result based on the target domain adapter corresponding to the information to be translated. Since each candidate domain adapter may correspond to at least one domain, when determining the domain adapter needed in the translation process, each candidate domain adapter enables the targeted selection of target domain adapters corresponding to the domain to which the information to be translated belongs, which helps to improve the accuracy of the translation.

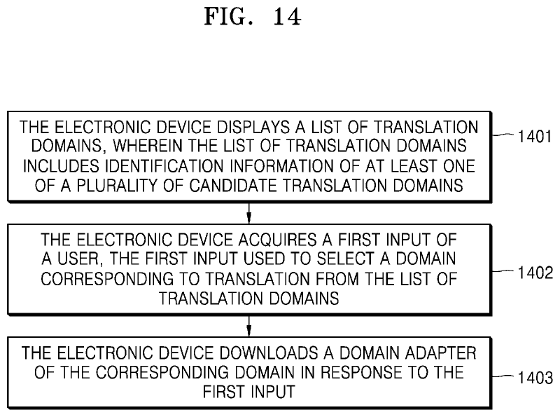

FIG. 14 is a schematic flow diagram of a method performed by an electronic device provided by the present disclosure, which may be a translation method, the electronic device may be a terminal or a server, which is not limited in the present disclosure. As shown in FIG. 14, the method includes the following operations 1401-1403.

In operation 1401, the electronic device displays a list of translation domains, where the list of translation domains includes identification information of at least one of a plurality of candidate translation domains.

For example, at least one domain included in the list of translation domains may be all or part of a plurality of candidate translation domains. For example, the at least one domain may be: recommending a plurality of hot domains to a user, or recommending to a user a domain of interest for the user, or the like.

In operation 1402, the electronic device acquires a first input of a user, where the first input used to select a domain corresponding to translation from the list of translation domains.

For example, the electronic device may acquire the first input, which may be the electronic device acquiring identification information of the domain selected by the user from the list of translation domains.

In operation 1403, the electronic device downloads a domain adapter of the corresponding domain in response to the first input.

In one or more examples, the electronic device may further prompt the user for a domain update, the process including: the electronic device displays the update prompt information for prompting the update of the domain corresponding to translation; the electronic device updates the domain adapter of the corresponding domain in response to the obtained update indication.

In one or more examples, the update prompt information may be used to prompt at least one of download of a new recommended domain, an update to a downloaded domain, or a deletion of a downloaded domain. The user may operate based on the displayed update prompt information. For example, the update prompt information may recommend the newly added domain, the domain of interest learned according to the user behavior, etc. to the user in real time. If the user triggers the download of the new recommended domain, the electronic device may download the domain adapter corresponding to the corresponding triggered new recommended domain based on the updated indication of the user's trigger. In one or more examples, if some of the domain adapters corresponding to domain among the domains that have been downloaded by the user have not been used for a long time, the user may be prompted to delete the domain adapters corresponding to those domains that are cold enabled.

The electronic device may preconfigure the machine translation module, in an offline translation scenario. When using the machine translation model of the present disclosure for offline translation, the technical solution may include:

For the first point, the user's first time to download the model.

In the related art, a mixture expert architecture-based machine translation model requires: 1. selecting a translation direction of the model (e.g., translation from Chinese to English); 2. downloading the entire machine translation model (including all parameters of all expert modules). Therefore, the volume of data to be consumed is large.

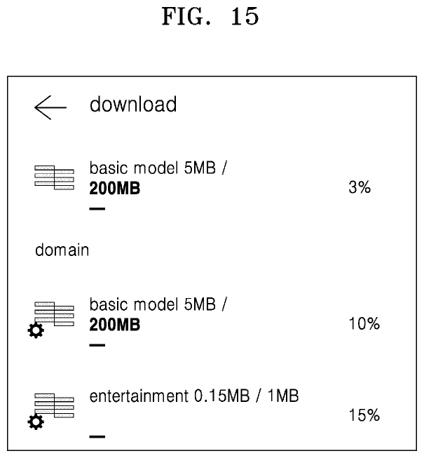

However, for the machine translation model, according to one or more embodiments of the present disclosure, the user only needs: 1. selecting the translation direction (domain) of the model; 2. downloading the necessary modules (e.g., the baseline machine translation model, the data distribution prediction module, the expert selector). For an expert module corresponding to each domain, the present disclosure may implement the following (1)-(2): (1) user receives a recommendation of a corresponding expert module for the user by using the user behavior big data; or (2) the user manually selects the required domain and downloads the corresponding expert module. For example, according to the user's browsing records, translation records, etc., a corresponding expert module of the domain that the user may prefer is recommended for the user. As shown in FIG. 15, in the present disclosure, the user only needs to download a base translation network including an encoder and a decoder, and a data distribution prediction module. For a particular domain, there is no need to download all domain adapters corresponding to the domain. For example, only the domain adapter corresponding to the default hot domain is downloaded. In one or more examples, only the domain adapter corresponding to the domain selected by the user is downloaded.

In one or more examples, the electronic device may also download an expert selector to support the selection of the word-level expert module during the translation. The expert selector may store the prototype database.

For the second point, the daily maintenance and update for the model usage phase is advantageously reduced. As an example, the model may have a size of around 200 MB, and each expert module may be around 1 MB);

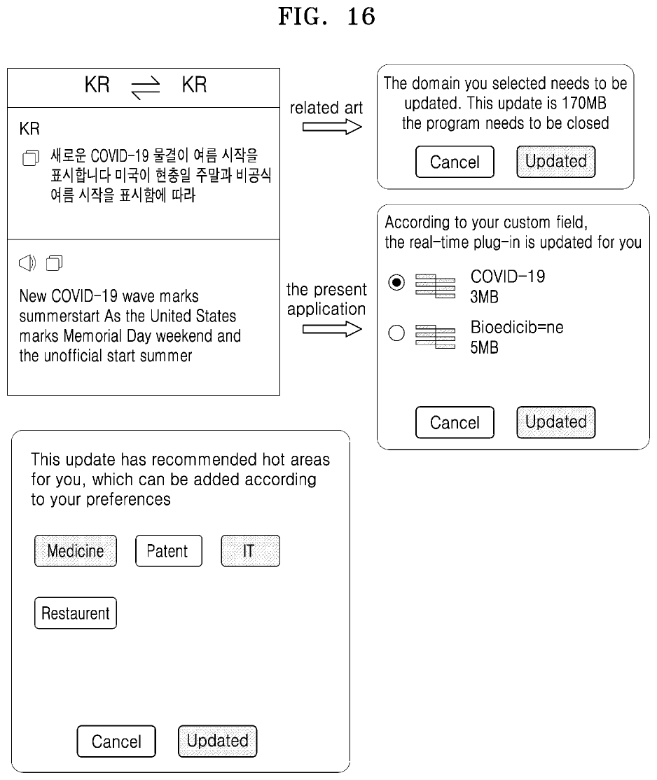

Each time the model is updated, in the related art, each update requires updating all the experts of the entire model. That is, the user needs to spend updating the traffic and time around 200 MB. As shown in FIG. 16, each time the model is updated, it is necessary to update the entire model (as illustrated as 170 MB in FIG. 16), which results in serious performance degradation.

However, for the machine translation model, according to one or more embodiments of the present disclosure, the user only needs to update an expert module corresponding to a certain domain that needs to be updated. Assuming that one expert module needs to be updated, only the time for updating the traffic and time around 1 MB is necessary. As shown in FIG. 16, the expert in the biomedicine domain needs only 5 MB (only 1 MB in the present example), and other domains are not affected. After a period of time is used by the user, the present disclosure may also automatically detect the domain of the user preferences, recommend the user to download an expert module in the corresponding domain, as shown in FIG. 16, recommend a hot domain of the user preference, recommend medicine, patent, IT, restaurant, etc., for the user, for user selection to add. Based on these features, the user experience with the model is significantly improved.

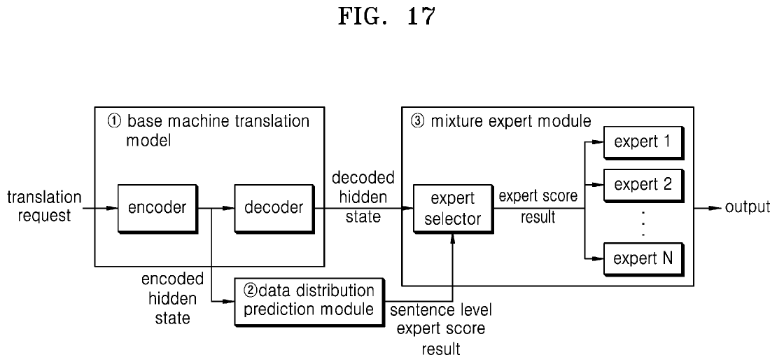

FIG. 17 is a network structural diagram of a machine translation model, according to one or more embodiments of the present disclosure. As shown in FIG. 17, the machine translation model may be a Fine Grained Decoupled Mixture of Expert (FGD-MoE) model. The machine translation model may include three modules: \textcircled{1} base machine translation models that include trained encoders and decoders; \textcircled{2} data distribution prediction module; \textcircled{3} a mixture expert module; . The mixture expert module may include expert selectors and individual expert modules. The data distribution prediction module may provide the prediction result. The prediction result may be a first score vector during the stage of using the trained machine translation model. During the training phase, the prediction result may be a score (e.g., a sentence level expert module score), of the data used by the training in the at least one data distribution category. The decoder may have a word-level decoding function that may provide the expert selector with the decoded hidden state of each target segment to support the expert selector in giving a more accurate word-level expert score, thereby matching the corresponding expert module to each target segment for translation. In contrast to the translation model network structure in the related art, each module in the present disclosure may be trained separately, and the necessary modules therein may be updated each time the model is updated, thereby allowing for lower training and deployment costs and improved model maintenance. The present disclosure may provide, through an expert selector, expert modules corresponding to the target segment, such as word-level expert modules for translation, which may improve the accuracy of translation, especially in a translation request including a plurality of domains.

In one or more examples, the electronic device may also update the modules in the local machine translation model based on the updated data.

In one or more examples, if a new domain adapter is added, the electronic device may receive the first update data and the second update data. The electronic device may update the data distribution prediction module based on the first update data, and the electronic device may add the newly-added domain adapter in the machine translation model based on the second update data.

In one or more examples, if the downloaded domain adapter needs to be updated, the electronic device may also receive the third update data, and update the corresponding downloaded domain adapter based on the third update data.

In one or more examples, if the electronic device downloads the expert selector, and if the domain adapter is newly added, the electronic device may also receive the fourth updated data, and update the locally stored expert selector based on the fourth updated data, such as updating the prototype database in the expert selector. The fourth updated data may include a domain feature vector of the newly added domain adapter, such as the hidden state center point of the newly added expert module.

The method of the present disclosure may display a list of translation domains to a user, where the list of translation domains includes identification information of at least one of a plurality of candidate translation domains. The method may further include, in response to a first input by a user, downloading a domain adapter of the corresponding domain selected in the list by the user, thus enabling translation to be completed by downloading only part of the domain adapter on the electronic device, compared to downloading all expert modules in related art, thereby saving traffic consumption and saving the space occupied by the model in the electronic device, relieving the limitation of the electronic device, and improving practical translation application.

The applicant of the present disclosure has studied the techniques of this field and finds that there are the following problems in the art:
1. A machine translation model usually needs to meet a number of domain translation requirements, such as Neural Machine Translation (NMT) models in related art, which may translate data in a plurality of domains. In the related art, a baseline NMT model is first trained with mixture data including a plurality of domains. The baseline NMT model is then fine-tuned by data in different domains, to obtain an NMT model of the corresponding domain. However, the applicant finds through research that it is necessary to obtain in advance which domain the data to be translated belonged to before in order to invoke the NMT model of the corresponding domain, and that the overall NMT model is large in size, leading to the technical disadvantage of poor practical translation application.
2. In the related art, mixture expert models may be used to meet a number of domain translation requirements. A mixture expert model architecture-based translation model in the related art typically includes a gated network and a plurality of experts. The applicant has found, however, through significant effort by studying the training process of the translation model that during its training phase, the order of the expert and the decoding capabilities of the expert are both affected by the learning result of the gated network, while the learning result of the gated network is uncontrollable. For example, when training iteratively, the gated network does not select the same experts for the same data in different batch trainings, resulting in a large variation of results. In the related art, to ensure consistency of the ability of the expert module and the gated network, all of the modules of the translation model must be highly coupled (e.g., all of the modules in the translation model need to be jointly trained). That is, even if there is an update to the dataset for a particular domain, all modules of the translation model (e.g., all experts), have to be trained, and all model parameters have to be adjusted; thereby increasing the cost of model training and leads to the technical disadvantage of less efficient training.

In particular, for models deployed to user devices, all parameters of the model local to the device need to be updated for each training, resulting in a large consumption of network resources, and leading to the technical disadvantage of high update costs and low update efficiency. Moreover, for other domains that do not need to be updated, the highly coupled joint training approach tends to cause performance regression in other domains, leading to the technical disadvantage of reduced translation quality.

To resolve the above described problems, the present disclosure provides a model training method in which the present disclosure contemplates a technical idea of performing decomposing training on each modules in the machine translation model. For example, the trained codec module may be fixed, the data distribution prediction module may be trained, and then the trained data distribution prediction model is fixed, where the mixture expert module in the machine translation model is trained by using the trained data distribution prediction module.

The mixture expert module may include various expert modules for implementing the processing flow corresponding to one of corresponding candidate domain adapters in the translation method flow (e.g., the process of converting the decoded features). In the training method flow described below, the expert module may be referred to as the corresponding candidate domain adapter.

During the training phase, the datasets may be classified by using the data distribution prediction module. The number of expert modules required to be trained may be determined based on the results of the classification (e.g., one category may correspond to one expert). There may be 12 categories in total, corresponding to 12 experts. As understood by one of ordinary skill in the art, it is also possible to design the technical idea that each decoding level may correspond to its own multiple expert modules, where assuming a total of 3 decoding levels, each corresponding to 12 expert modules, there are 36 expert modules in total. Based on these feature, during the training phase, the first score vector output by the data distribution prediction module is a score corresponding to each category; whereas in the use of the trained machine translation model phase, the first score vector output by the data distribution prediction module is a score corresponding to each expert module (e.g., each candidate domain adapter).

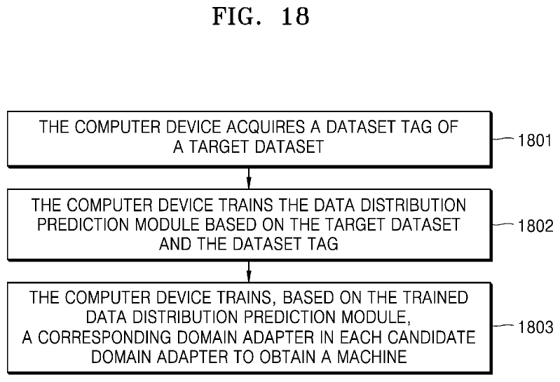

The model training method is described below with respect to the flowchart shown in FIG. 18:

FIG. 18 is a schematic diagram of a method performed by an electronic device provided by one or more embodiments of the present disclosure. The method may be a model training method. As shown in FIG. 18, the method includes the following operations 1801 to 1803.

In operation 1801, the electronic device acquires a dataset tag of a target dataset.

A dataset tag may characterize a data distribution category of each data in the target dataset. The dataset tag may include a category tag of each data in the target dataset, the category tag of each data identifies the category of data distribution for that data. The data distribution category of the data may characterize the classification to which the semantic features of the data belong. The present disclosure may classify at least one data with the same or similar semantic features as a data distribution category. The target dataset may include at least one data, which may be translated source data. For example, the translation requirement may be to translate the Chinese sentence to an English sentence, and the target dataset may include a plurality of Chinese sentences. In the present disclosure, the target dataset is the data used when training the data distribution prediction module.

In one or more examples, the electronic device may acquire semantic features of at least one data in the target dataset, determine a data distribution category of each data based on semantic features of the at least one data, and obtain a dataset tag of the target dataset. In one or more examples, semantic features may be represented as semantic feature vectors that include feature data of the data in at least one dimension.

In the present disclosure, a machine translation model may include a codec module, a data distribution prediction module, and a mixture expert module. The electronic device may first train a codec module to obtain a trained encoder and retrain the data distribution prediction module. In one or more examples, semantic features of the data may be obtained by a trained encoder in a machine translation model, and the semantic features may represent an encoded hidden state vector obtained from feature extraction of the data by the encoder. One or more examples of operation 1801 may include: the electronic device acquires, by a trained encoder, a first encoded feature of at least one data in the target dataset; and determines, based on the first encoded feature of the at least one data, a data distribution category of the at least one data, to obtain the dataset tag, where the first encoded feature may be an encoded hidden state vector.

In one or more embodiments, the target dataset includes at least a first dataset obtained by sampling a source dataset to be translated. In one or more embodiments, the target dataset may include a first dataset and a second dataset belonging to the target domain. The electronic device may obtain the dataset tags in different categories based on different sources of data included in the target dataset. Accordingly, the implementation of operation 1801 may include the following three manners.

In manner 1, the target dataset includes a first dataset. For manner 1, the execution process of operation 1801 may include the following operations 1801_a1801_b.

Operation 1801_a, the electronic device acquires, based on the trained encoder, a first encoded feature, such as an encoded hidden state vector, of each first data in the first dataset.

In operation 1801_b, the electronic device classifies, based on the first encoded features of each first data, each first data to obtain a dataset tag of the target dataset.

Prior to performing operation 1801, the electronic device may first train a codec module to obtain a trained encoder; and retrain the data distribution prediction module.

In this operation, the electronic device may perform the feature extraction on the first data by the trained encoder to obtain an encoded hidden state vector of each first data. The manner in which the first encoded feature of each first data may be acquired is the same as in operation 202_a, as described above.

In one or more examples, a clustering manner may be used to cluster each data in the target dataset into a plurality of data distribution categories. In one or more examples, the electronic device may cluster each first data based on the encoded hidden state vector of each first data, to obtain a cluster tag for each first data; and use the cluster tag for each first data as the dataset tag. The cluster tag for each first data represents a data distribution category of the first data. For example, the electronic device may cluster the first dataset in a manner that supervised clustering, or unsupervised clustering. For example, the degree of similarity between the data may be measured by the vector distance, the smaller the vector distance, the closer the feature distributions of the two data, the greater the degree of similarity of the two data. The electronic device may cluster similar data into one data distribution category by calculating a vector distance between the encoded hidden state vectors of every two first data.

In one or more examples, the electronic device may acquire a source dataset in the machine translation total dataset and sample the source dataset to obtain the first dataset. The machine translation total data may include the source dataset and the translation result data of the source dataset. For example, for the Chinese to English translation requirements, the source data is a Chinese sentence, and the translation result data is an English sentence. The source dataset may include data in a plurality of domains, the electronic device may randomly sample the source dataset to obtain a first dataset, and the data distribution of the first dataset in each domain may be the same as or similar to this source dataset. For example, the data volume of the source dataset is 1 million, the proportion of data belonging to the above four domains of legal domain, medical domain, spoken language domain, and patent domain in the 1 million source dataset is 20%, 25%, 32% and 5%, and the first dataset with a data volume of 1000 may be obtained by sampling from the 1 million source dataset. The proportion of data belonging to the above four domains in the first dataset may be 20%, 25%, 31%, 4%. For example, by using manner 1, a first dataset of 1000 may be randomly sampled from a data volume of 1 million source datasets and clustered into 12 data distribution categories, each corresponding to one expert module in the mixture expert module.

For example, the codec module may be a generic NMT model, the first dataset may be randomly sampled from the training set of the generic NMT model, the data distribution of the first dataset may be the same as or similar to the data distribution of the training set of the generic NMT model. For example, S^{D}≈S^{T}, the data distribution prediction module may be a discriminator (classifier), S^{D} represents the data distribution of the target dataset used by training the data distribution prediction module, S^{T} represents the data distribution of the training set of the generic NMT model.

In manner 2, the target dataset includes a first target dataset and a second dataset. For manner 2, the execution process of operation 1801 may include the following operations 1801_c-1801_d.

In operation 1801_c, the electronic device, based on the trained encoder, acquires a first encoded feature of each first data in the first dataset and a first encoded feature of each second data in the second dataset.

In operation 1801_d, the electronic device clusters each first and second data based on the first encoded features of each first and the second data, and the domain tag corresponding to each second data, to obtain a dataset tag of the target dataset.

The electronic device may use the first dataset and the second dataset as the target dataset and cluster each data (including each first and second data) in the target dataset, to obtain a dataset tag. The dataset tag may include a cluster tag of each first data and a cluster tag of each second data.

The second dataset may be a dataset that belongs to the target domain. The following is an example of three example scenarios for this second dataset with three example applications.

In scenario 1 1, the target domain may be the domain in which the volume of data conforms to a preconfigured condition.

In one or more examples, the target domain may be a domain of a plurality of domains corresponding to the source dataset for which the sampled data volume meets the first condition, the sampled data volume represents the volume of data in that domain sampled from the source dataset. For example, the sampled data volume may be the volume of data of the domain included in the first dataset. The second dataset may then be acquired in a manner comprising: the electronic device acquires the volume of data belonging to each domain in the first dataset, uses the domain whose volume of data conforms to the first condition as the target domain based on the volume of data included in each domain, and acquires a second dataset belonging to the target domain. For example, the first condition may include, but is not limited to, that the data included in the first dataset is less than a first data volume threshold, or that the data volume is less than a second data volume threshold, etc. If the percentage of domain A in the source dataset is 5%, and the percentage of the sampled domain A in the first dataset is 4%, the data volume is 4, 6% below the first data volume threshold and also below the second data volume threshold of 10, then a second dataset of domain A may be additionally acquired.

For the domain of less sampling data, by additionally acquiring a second dataset in the domain of less sampling data to increase the training samples in the domain of less sampling data, such that even a small domain of less data may learn better translation capabilities to remove the disadvantage of small volume of data in some domains and ensure the translation quality of small domains, thereby resulting in the trained translation machine model achieving a high level of translation quality in all domains.

In scenario 2, the target domain may be the domain in which the translation quality conforms to the second condition.

The manner in which the second dataset may be acquired includes: the electronic device acquires, based on the translation quality of the machine translation model in each domain, a second dataset that the translation quality conforms to the second condition. For example, the second condition may include, but is not limited to: the translation quality being below a first quality threshold, pre-configured translation quality to be achieved is above the second quality threshold, or the like. For example, the electronic device may count the translation quality of the data in each domain during the iterative training process, and for domains with low translation quality, the electronic device may set them as target domains to increase the training sample for the low-quality domain and optimize their translation quality by additionally acquiring a second dataset of the domain with lower translation quality. For example, the translation quality to be achieved may be a pre-configured translation quality. For example, for some key domains where a higher translation quality needs to be achieved, the translation quality may also be further improved by additionally acquiring a second dataset of the key domains to increase the training samples of the key domains.

For example, the domain B where the translation accuracy rate is less than 50% during the iterative training process may be set as the target domain, and additional datasets of domain B may be acquired for training. Whereas for the domain C where the achievement accuracy rate is 90%, the domain C where the translation accuracy rate is less than 90% during the iterative training process, may be set as the target domain, and additional datasets of domain C may be acquired for training.

In scenario 3, the target domain may be the domain corresponding to the dataset to be updated.

In this scenario, the acquisition of the second dataset may include: the electronic device determines the target domain corresponding to dataset to be updated and samples the second dataset from the updated data in the target domain. For example, the machine translation module may provide translation requirements in 20 domains. For example, for the newly added domain M, domain N, the domain M includes an volume of data 5000, the domain N includes an volume of data 6000, the domain M and the domain N may be set as the target domain, and the newly added volume of data in the domain M and domain N is sampled, for example, a dataset m with a volume of data 50 is sampled from the newly added volume of data 5000 in domain M and a dataset n with a volume of data 60 is sampled from the newly added volume of data 6000 in domain N. The data m and data n are clustered into category 13, corresponding to the exclusive expert module 13 when clustering.

The above scenarios, such as the volume of data, translation quality, or data update, described above, for example, illustrate several example conditions of the second dataset. As understood by one or ordinary skill in the art, the target domain may be otherwise obtained for other example application scenarios. For example, the target domain may also be a designated domain preconfigured by the user, the electronic device acquires the second dataset based on the designated domain preconfigured. As understood by one of ordinary skill in the art, it is also possible to configure different target domains according to different application scenarios. The present disclosure is only illustrated by the above-mentioned examples, but there is no specific limitation on how to acquire the target domains, the applicable scenarios, etc.

In one or more examples, the electronic device may cluster each first and second data based on the encoded hidden state vectors of each first and second data, and use the domain tag corresponding to each second data as the cluster support point and cluster the data in the target dataset belonging to the target domain into at least one independent data distribution category, to obtain the cluster tag of each first and second data. In one or more examples, the cluster support points may be used to cluster the target domain as the independent data distribution category during clustering. The data of the target domain may be clustered into at least one independent category. An independent category may be understood that the percentage of data in the target domain in that independent category exceeds the target percentage threshold. In one or more examples, the target domain may include at least one domain, the electronic device may cluster the plurality of domains into one or more independent data distribution categories when the target domain includes a plurality of domains. For example, for domain E and domain F with less than the volume of data 10, dataset e of domain E and dataset f of domain F are additionally acquired, and dataset e and dataset f are clustered into an independent category 13, with more than 90% of the data in category 13 belonging to domain E and domain F.

In one or more examples, in the case of a K-Means clustering algorithm, the electronic device may classify the target dataset into K groups, where the data of the target domain is considered as at least one independent group, and K cluster centers are selected from the K groups, and the K cluster centers include at least data belonging to the target domain. The electronic device may divide each data into a data distribution category of a similar cluster center based on a vector distance between each data in the target dataset and the K cluster centers. The electronic device may further update a cluster center of each data distribution category based on the newly added data in each data distribution category, and repeat the above operations until a termination condition is achieved, to obtain a final plurality of data distribution categories. The target domain may correspond to at least one independent category among the plurality of data distribution categories. For example, due to the small size of the data, the data distribution of some small domains may be subordinated to the data distribution categories of large-scale domains when the categories are divided. For small domains that require attention, the present disclosure may additionally use the source data of some small domains as clustering support points, and inject the dataset of such mixed small domains into a randomly sampled first dataset to obtain the target dataset. For example, S^{A} represents the data feature distribution of the second dataset of the target domain, S^{D}≈(nᵣS^{T}+nₐS^{A})/(nᵣ+nₐ); where nᵣ and nₐ are the data measurement of the first dataset and the second dataset respectively, and the data measurement is the volume of data that measures the size of the data; the first dataset may be randomly sampled from the training set of the generic NMT model, S^{D} represents the data distribution of the target dataset used for the training of the data distribution prediction module, and S^{T} represents the data feature distribution of the training set of the generic NMT model. After the two datasets are combined, the data features may also be fused, and if the data size of one dataset is relatively small and the other dataset is relatively large, after the two datasets are combined, the data feature distribution of the combined dataset will be more biased towards dataset whose date size is relatively large.

When the target domain includes a plurality of domains, the data in the target domain may be clustered into one or more categories; that is, the plurality of domains may not be a one-to-one correspondence with the plurality of categories, but the plurality of domains may correspond to exclusive data distribution categories, the data distribution categories in the machine translation model correspond to each expert modules in the mixture expert module, and the plurality of domains may correspond to the exclusive expert modules. For example, for domains E and F in the first dataset with less than 10 data volumes, the data belonging to domains E and F in the target dataset may be clustered into an independent category 2, with category 2 corresponding to an exclusive expert module 2, and the trained expert module 2 is subsequently used to specifically translate the data in category 2, which greatly improves the translation quality of domains E and F. Thus, by using manner 2, the data of the target domain is clustered into an independent data distribution category, such that the independent category may correspond to an exclusive expert module, thereby improving the translation quality of the target domain.

In manner 3, the target dataset includes a first target dataset and a second dataset.

For manner 3, the execution process of operation 1801 may include the following operations 1801_e, 1801_f, 1801_g.

In operation 1801_e, the electronic device acquires, based on the trained encoder, a first encoded feature of each first data in the first dataset.

In operation 1801_f, the electronic device clusters, based on the first encoded features of each first data, each first data to obtain a dataset tag of the first dataset.

In operation 1801_g, the electronic device sets a domain tag corresponding to each second data in the second dataset as a dataset tag of the second dataset.

In manner 3, there may be a one-to-one correspondence between a domain tag of the target domain and the data distribution category, and the electronic device may consider each domain in the target domain as an independent data distribution category (e.g., a domain tag of each data in the second dataset is a category tag of the data). For example, for dataset e of the domain E and dataset f of domain F which are additionally acquired, the dataset e belongs to category 13 corresponding to domain E, and dataset f belongs to category 14 corresponding to domain F.

In one or more examples, the second dataset in manner 3 may also include three conditions. In example 1, the electronic device may, based on the volume of data included in each domain, consider a domain whose volume of data conforms to a preconfigured first condition as a target domain and acquire a second dataset belonging to that target domain. In example 2, the electronic device may acquire a second dataset whose translation quality conforms to the second condition based on the translation quality of the machine translation model in each domain. In example 3, the electronic device may determine the target domain corresponding to the dataset to be updated and samples the updated data from the target domain to obtain the second dataset. The second dataset in the above three conditions may be acquired in the same way as in manner 2 above.

The first encoded feature may be extracted from data such as the first data or the second data in the same way as in operation 202_a. The clustering of each first data in operation 18012c may be performed in the same manner as the clustering in 1801_b above. In manner 3, the second dataset of the target domain may be maintained as an independent data distribution category and concatenated with the data distribution category obtained by the clustering. For example, based on the randomly sampled clustering results, the second dataset of the target domain may be used as an additional data distribution category and is concatenated with the category of the first dataset clustering category to obtain the target dataset and its dataset tags.

After constructing a target dataset for use in training the data distribution prediction module in the three manners described above, the target dataset may be used to train the data distribution prediction module by the following operation 1802.

In operation 1802, the electronic device trains the data distribution prediction module based on the target dataset and the dataset tag.

In the present disclosure, the dataset tag may be used as a sample truth value tag of the target dataset, a prediction result of the target dataset may be obtained by the data distribution prediction module, the prediction result characterizing the data distribution category of each data in the target dataset, and the data distribution prediction module may be trained based on the dataset tag and the prediction result. During the training phase, the data distribution prediction module may be used to predict a probability that each data in the target dataset belongs to each data distribution category, each data distribution category corresponding to at least one domain.

In one or more examples, operation 1802 may include the following operations 1802_a to 1802_b.

In operation 1802_a, the electronic device acquires a prediction result of the data distribution prediction module on the target dataset.

The electronic device may input an encoded hidden state vector of each data in the target dataset to the data distribution prediction module, and obtain the prediction result by the data distribution prediction module.

In one or more examples, the manner in which the data distribution prediction module acquires the prediction result may be similar to the process of acquiring the first indication information based on the first encoded feature in operation 202_b. For example, an encoded hidden state vector of a 1×512 dimension may be mapped to a score of data in 12 data distribution categories by a mapping operation such as a linear mapping or a non-linear mapping.

In one or more examples, this prediction result may be obtained by the network structure as shown in FIG. 3, for example, obtaining a 1×12-dimensional score vector l^{D} that includes scores of the data in the 12 data distribution categories.

In operation 1802_b the electronic device trains the data distribution prediction module based on the dataset tag and the prediction result.

In one or more examples, a training loss may be obtained by comparing the difference between the dataset tag and the prediction result, and the data distribution prediction module may be iteratively trained based on the training loss.

When training the data distribution prediction module, how to obtain a data distribution tag for untagged sample data (e.g., a sample tag), is a very important, highly desirable problem for training the data distribution prediction module. In the present disclosure, first by acquiring a target dataset, a set of sentences of source data used in training the data distribution prediction module may be constructed, and a pooling operation may be performed in the word sequence dimension of the encoded hidden state vector of each sentence to compress the word sequence dimension, for example, by descending the word sequence dimension from n to 1, to obtain a 1×512 dimensional vector ĥ as a feature vector characterizing the semantic features of the sentence. These sentences may then divided into at least one data distribution category by using the vectors ĥ, in a manner of unsupervised clustering, for example. The cluster tag of each sentence may serve as its true tag.

The data distribution prediction module may be trained in a supervised training manner by using the target dataset. Based on this, the training result of the data distribution prediction module may be made controllable by a supervised training manner, even if the data distribution prediction module is trained separately and independently from the mixture expert module and the codec module, the modules and the modules do not affect each other. For example, after the data distribution prediction module has been trained, even if there is a dataset update, the data distribution category of the updated dataset may be determined by the data distribution prediction module, thereby determining the expert module corresponding to the data distribution category, and thereby training only the expert module corresponding to the updated dataset, thus, greatly reducing the training cost.

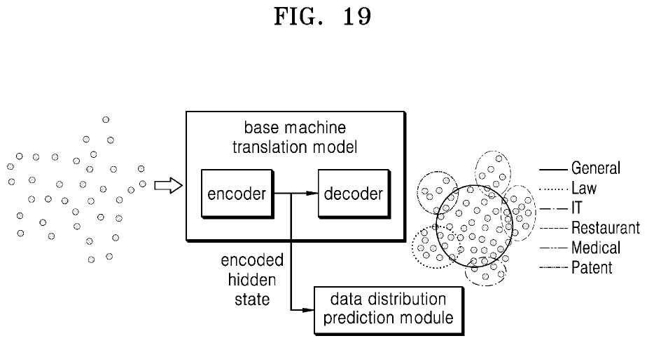

In one or more examples, as shown in FIG. 19, during the training phase, the training data may be encoded into an encoded hidden state vector (e.g., referred to as an encoded feature) by using an encoder module of the baseline machine translation model, and then the data distribution prediction module may be trained by using the optimization objective of the multi-classification task [symbol] _{d}=−Σᵢ₌₁ⁿ yᵢ log [symbol] where, yᵢ is a category tag; n is the number of categories (e.g., the number of data distribution categories); and [symbol] refers to a predicted probability of the data distribution prediction module. As a result of the training phase, as illustrated in FIG. 19, the following domains may be identified: General, Law, IT, Restaurant, Medical, Patent, etc.

After the trained data distribution prediction module may be obtained by operation 1802 described above, network parameters of the data distribution prediction module may also be fixed to train each candidate domain adapter.

In operation 1803, the electronic device trains, based on the trained data distribution prediction module, a corresponding domain adapter in each candidate domain adapter to obtain a machine translation model.

Each candidate domain adapter may correspond to at least one domain.

The electronic device may train each candidate domain adapter by using the training datasets as samples. The training dataset may be source data to be translated, the training dataset corresponding to a translation truth value dataset as the sample truth value. For example, if the translation requirement is to translate Chinese sentences to corresponding English, the training dataset may include a large number of Chinese sentences, with each Chinese sentence corresponding to an English sentence as the sample truth value.

The electronic device may acquire, via a trained data distribution prediction module, a prediction result of the training dataset, the prediction result characterizing a data distribution category of each data in the training dataset; and determine, based on a correspondence between the data distribution category and each expert, a target domain adapter corresponding to each data. The electronic device may further obtain, based on the target domain adapter corresponding to each data, a translation result of each data, and train each candidate domain adapter based on the translation result of each data and the translation truth value data. In one or more examples, the execution process of operation 1803 may include the following operations 1803_a, 1803_b, 1803_c, and 1803_d.

In operation 1803_a, the electronic device acquires a prediction result of the training dataset based on the trained data distribution prediction module.

In one or more examples, the electronic device acquires an encoded hidden state vector of the training dataset based on the trained encoder, and performs a data distribution prediction on the training dataset based on the encoded hidden state vector through a trained data distribution prediction module, to obtain a prediction result of the training dataset. In one or more examples, the prediction results may characterize a data distribution category of each data in the training dataset. For example, the prediction result may include a score of each data in the training dataset in at least one data distribution category.

In one or more examples, obtaining the prediction result of the training dataset through the trained data distribution prediction module may be the same process as the acquiring the prediction result of the data distribution prediction module for the target dataset in operation 1802 above.

In operation 1803_b, the electronic device determines, based on the prediction result of the training dataset, the target domain adapter corresponding to each data in the training dataset in each candidate domain adapter.

In this operation, the electronic device may determine, in units of data, a target domain adapter corresponding to each data to facilitate subsequent use of the target domain adapter corresponding to the data to obtain the translation result. In one or more examples, the electronic device may also refine the expert classification granularity. For example, each target segment in the sequence may also be output based on the translation result to be output, each target segment may correspond to a target domain adapter to facilitate subsequent use of the target domain adapter of each segment to obtain each target segment. For example, the data may be a Chinese sentence, the translation result may be one corresponding English sentence, and the target segment may be each English word included in the English sentence. For example, the electronic device may directly determine the sentence level domain adapter; or, a word-level domain adapter corresponding to each English word in the output sequence of the English sentence may also be determined. Accordingly, the present operations may include the following two implementations.

In manner 1, the electronic device may determine, based on the data distribution category of each data in the training dataset characterized by the prediction results, a candidate domain adapter corresponding to each data from a correspondence between the data distribution category and the candidate domain adapter. In one or more examples, the candidate domain adapters corresponding to each data distribution category may be configured in each of the initial candidate domain adapter, and the correspondence between the data distribution category and the candidate domain adapter may be recorded so that the corresponding candidate domain adapter is selected based on the data distribution category of the data.

In one or more examples, the prediction result may include a score of each data in the training dataset in at least one data distribution category. The electronic device may then determine a data distribution category of each data based on the score of each data in the at least one data distribution category.

In one or more examples, the electronic device may consider the data distribution category whose score conforms to the target score condition as the data distribution category of the data directly based on the score of each data in at least one data distribution category, and determine a target domain adapter corresponding to the data based on the data distribution category of the data. For example, the target score condition may include, but is not limited to: data distribution category with the highest score, the data distribution category corresponding to any of the first numerical scores in the descending sequence of scores, or the first numerical scores and no lower than the second numerical value, etc. For example, the data distribution category with the highest score may be used as the data distribution category of the data.

In one or more embodiments, the prediction result may be noise influenced, and the data distribution category may be determined by using the result of the noise effect. In one or more examples, operation 1803_b may include: the electronic device determines a probability vector of each data based on the prediction result, and performs a noise processing on the probability vector of each data to obtain a target domain transition corresponding to each data. In one or more examples, the probability vector of any data may characterize the probability that the data belongs to a candidate category in the at least one data distribution category. For example, noise may be added to the probability vector of each data and the domain transition corresponding to the category with the highest probability may be selected based on the probability vector after adding noise.

The electronic device may filter at least one score from the prediction results, which may then mapped to a probability vector and noise is added. In one or more embodiments, the execution process of operation 1803_b may include the following operations A1 to A5:

In operation A1, for any data in the training dataset, the electronic device filters out at least one score that conforms to a preconfigured condition from the prediction results of the data, to obtain a target score vector of the data.

The target score vector may include a score for the data in at least one candidate category. In one or more examples, the preconfigured conditions may include, but are not limited to: a score at the first target value position in a descending sequence of scores, the score at the first second target value position in a descending sequence of scores and the score value higher than the third target value, etc. As an example, for the score at the first target value position in the descending sequence of score, the electronic device may acquire the target score vector of each data by using the following Equation 8.

l′=topk′(l); Equation 8:

Where, l represent the data distribution scoring result, l may represent the prediction score vector. For example, the training dataset includes 1000 data, the data distribution prediction module may be used to obtain scores of each data corresponding to the 12 clustering categories, l may be expressed as a 12×1000 prediction score vectors. In Equation 8, l′ represents the target score vector, and l′ represents the first k′’ scores with higher scores filtered out from l. For example, if the first 3 scores with the highest scores are selected, then l′ represents a 3×1000 target score vector.

In operation A2, the electronic device maps the target score vector to a probability vector of the data.

The electronic device may obtain the probability of the data in each data distribution category based on the size of each score in the target score vector of the data, the larger the score, the greater the probability. In one or more examples, each score in the target score vector may be normalized to a probability value not greater than 1 by normalization. For example, the scores of the data in each data distribution category may be presented as probabilities by the normalized exponential function softmax. This electronic device may map this target score vector to a probability vector of that data by the following Equation 9:

p=softmax(l′/r); Equation 9:

Where, l′ represents a target score vector, p represents a probability vector. If l′ represents a 3×1000 target score vector, then p also accordingly represents a 3×1000 probability vector. r is a hyperparameter that may be used to control the distribution of probabilities in a probability vector, where the value of the hyperparameter may be preconfigured. The value of the hyperparameter may be configured based on the need. The larger the value of the hyperparameter, the smaller the difference between the plurality of probabilities included in the probability vector of the same data. The smaller the value of the hyperparameter, the closer to the one hot distribution between the plurality of probabilities included in the probability vector of the same data.

In operation A3, the electronic device adds noise in the first probability vector of the data to obtain a second probability vector.

To facilitate differentiation, the probability vector before noise is added is referred to as a first probability vector, and the probability vector after noise is added is referred to a second probability vector. The first probability vector may include a probability of the data being in at least one candidate category, and the second probability vector may include a noise probability of the data being in the at least one candidate category.

In one or more examples, the electronic device may add a Gumbel noise in the first probability vector by the following Equation 10, to obtain a second probability vector:

G(p)=log(p)+g; Equation (10):

Where, g represents the addition of the noise subject to the Gumbel distribution. G(p) represents a second probability vector after noise is added, p represents a first probability vector. The addition of noise may enable the data distribution of G(p) is not fixed, providing randomness of obtaining the data distribution category and the target domain adapter based on G(p). For example, the first probability vector of data A is (0.41, 0.39, 0.08), 0.41, 0.39, 0.08 represents the probability that data A belongs to category 1, category 2, and category 5, respectively. The noise probability that data A belongs to category 1 in the second probability vector after adding noise may still be greater than the noise probability that belongs to category 2, or the noise probability that data A belongs to category 1 may be less than the noise probability that belongs to category 2. For example, in the current 80 iterative training processes, data A has been assigned 42 times to the expert 1 corresponding to category 1, and data A has been assigned 37 times to the expert 2 corresponding to category 2.

By the probability vector noise processing, the randomness of the noise probability distribution may be increased, especially when the difference in probabilities of the data in at least two categories is small, and it is possible to make the category with the smaller probability value in the plurality of categories with a smaller probability difference also serve as the category of the data, corresponding to the expert module of the category with a smaller probability value of the data respectively. Thus, data belonging to ambiguous categories may be equally assigned to different expert modules, increasing the training data of the expert modules corresponding to categories with small differences, improving the overall robustness of the model and hence the translation quality.

In operation A4, the electronic device determines, based on the second probability vector, a target category of the at least one candidate category.

For the noise probability of at least one candidate category in the second probability vector, the electronic device may select a candidate category with the maximum noise probability from the at least one candidate category as the target category.

In operation A5, the electronic device determines, based on a correspondence between the data distribution category and the candidate domain adapter, that the candidate domain adapter corresponding to the target category is a target domain adapter corresponding to the data.

The electronic device may be preconfigured with a correspondence between the data distribution category and the candidate domain adapter. For example, 12 categories correspond to 12 candidate domain adapters. In one or more examples, the target category may be obtained by the following Equation 11:

c=argmax(G(p)); Equation 11:

Where, c represents the finally determined expert module, c may be the serial number of the final determined target domain adapter; argmax(G(p)) represents the candidate domain adapter, which may correspond to the category with the maximum noise probability.

The sentence may be assigned to the most appropriate target domain adapter, and the data distribution category to which the sentence belongs is determined. One simple strategy may be to select the data distribution l^{D} with the largest category score. However, since one sentence may be considered to be extracted from a mixture of several domains, its classification may be ambiguous. During the candidate domain adapter training phase, the applicant has found through research that, a straightforward task may prevent sentences from being assigned to a corresponding category. For example, if the score of a certain data in category 1 is higher than in category 2, the straightforward task will directly select the category with the maximum score as the category of that data. However, the difference between the score in category 2 and the score in category 1 is small. For example, the probability of the data belonging to category 2, and the probability of belonging to category 1 are close, and the straightforward task will directly ignore considering the case of category 2. Thus, for the corresponding categories with similar scores, but the scores being lower than the maximum score, the straightforward task also prevents these sentences from being assigned to candidate domain adapters of the corresponding categories with similar scores, but the scores being lower than the maximum score, thereby reducing the training set of these candidate domain adapters to some extent.

By using Gumbel noise during training and taking the maximum value of the noise probability to assign the candidate domain adapters, the application makes it possible for sentences belonging to ambiguous categories to be advantageously assigned to different candidate domain adapters depending on their noise probabilities. The training set of these candidate domain adapters may be increased by the fact that ambiguous sentences may be classified into multiple suitable candidate domain adapters, which makes these candidate domain adapters more robustly trained. The training set of candidate domain adapters may be enriched and balanced, which improves the overall robustness of the model and hence the translation quality of the model.

In manner 2, the translation result corresponding to each data includes at least one target segment corresponding to the data, the target domain adapter corresponding to each data including a target domain adapter corresponding to each target segment. Operation 1803_b may include the following operation B1:

In operation B1, for each data, the electronic device determines, by the expert selector, a target domain adapter corresponding to each target segment based on the prediction result of the data and the second indication information of each target segment corresponding to the data.

The second indication information may characterize the likelihood that each candidate domain adapter is a target domain adapter of the target segment. The second indication information may be a second score vector, for example.

In one or more examples, the mixture expert module may include an expert selector for providing an expert module that data may correspond to each target segment in the target language; where the translation result of each data includes at least one target segment; and the target segment may be part of the data in the translation result output sequence to be output. For example, the data may be a Chinese sentence, the translation result may correspond to an English sentence, the target segment may be an English word or phrase in the English sentence. Furthermore, the expert module corresponding to the data may be a sentence level expert module, while the expert module of the target segment may be a word-level expert module. The present disclosure is subsequently exemplified only by the sentence level expert module and the word-level expert module, but there is no limitation on the target segment and its corresponding expert module. As understood by one of ordinary skill in the art, in one or more examples, the data may be a paragraph that includes a plurality of Chinese sentences, the translation result may correspond to a paragraphs of English sentences, the target segment may be an English phrase or an English sentence, etc. The expert module corresponding to the data may be a paragraph-level expert module, and the expert module of the target segment may be the sentence-level expert module.

In one or more examples, the expert selector may store a prototype database that stores the hidden state center points of each expert module; and the target domain adapter that is most similar to each target segment may be determined by using the hidden state center point of the expert module and the decoded hidden state of the target segment. In one or more examples, the operation B1 implementation may include the following operations C1 and C2:

In operation C1, for each target segment, the electronic device may obtain, by the expert selector, the second indication information corresponding to the target segment based on a similarity between the target decoded feature corresponding to the target segment and the domain feature vector of each candidate domain adapter, respectively.

The second indication information may include a score of the target segment at the at least one expert module. For example, the second indication information may be a second score vector of the target segment.

In operation C2, the electronic device may integrate the prediction result of the data and the second indication information corresponding to the target segment to obtain a target domain adapter corresponding to the target segment.

In this operation, the prediction result and the second indication information are integrated to obtain the third indication information; the process is the same as the operation S4 and operation S6. The prediction result may include a score that each candidate domain adapter is a target domain adapter. For example, a prediction result of the data may be predicted by using the data distribution prediction module, and the prediction result may include a score of the expert module corresponding to the data in at least one data distribution category.

The electronic device may integrate the prediction result of the i^{th} target segment and the second indication information by the following Equation 12 to obtain the final, third indication information when predicting the i^{th} target segment wᵢ:

P_{w}_{ᵢ}=interpolation(Pₜ,Pₛ); Equation 12:

Where, P_{w}_{ᵢ} represents the third indication information corresponding to the target segment wᵢ. Interpolation represents an integration function. For example, the word-level score Pₜ at the k^{th} expert module may be expressed as: Pₜ=Sim([H_{out,1˜i}], DSₖ); the sentence-level score Pₛ at the k^{th} expert module may be expressed as: Pₛ(Ept=k|Eₒᵤₜ); the third indication information P_{w}_{ᵢ} at the k^{th} expert module may be expressed as: P_{w}_{ᵢ}(Ept=k|Hₒᵤₜ, Eₒᵤₜ, Pₛ)=interpolation(Sim([H_{out,1˜i}], DSₖ), Pₛ(Ept=k|Eₒᵤₜ)).

In one or more examples, the third indication information may include an integration score of the i^{th} target segment corresponding to at least one expert module. For example, the electronic device may filter at least one integration score, and map it to a probability vector and adds noise (e.g., the electronic device may select a final expert module for the i^{th} target segment by using the same process as operations A1 to A5 in operation 1803_b based on the third indication information).

As shown in Equation 13 below, the integration function may be:

$${interpolation}_{t} = N ( ( 1 - \frac{t}{T} ) {P}_{s} + \frac{t}{T} {P}_{t} , \frac{t ( T - t )}{T} ) ; \qquad Equation 13$$

Where, N( ) denotes a Gaussian function, t denotes the t^{th} target segment to be translated currently, T denotes the total number of target segments included in the translation result. In Equation 13,

$$( 1 - \frac{t}{T} ) {P}_{s} + \frac{t}{T} {P}_{t}$$

denotes the mean of the Gaussian function,

$$\frac{t ( T - t )}{T}$$

denotes the variance of the Gaussian function.

In one or more examples, the electronic device may set the Gaussian function according to the mean and variance and use the probability distribution of this Gaussian function to take a random value as the third indication information of the i^{th} target segment and determine the expert module corresponding to the target segment based on the third indication information.

During the training phase, the Gaussian function N( ) may be used to perturb the ratio of the word-level score Pₛ to the sentence-level score Pₜ by the variance of

$$\frac{t ( T - t )}{T}$$

during the training phase, enabling the model training phase to accommodate small variations in integration scores, thereby enhancing the robustness of the results and thus improving the accuracy and efficiency of the model training.

In the model prediction phase or the phase using a trained machine translation model, the variance of the Gaussian function may be set to zero, eliminating randomness and avoiding different translation results when the same data is translated multiple times, in order to obtain a stable expert score.

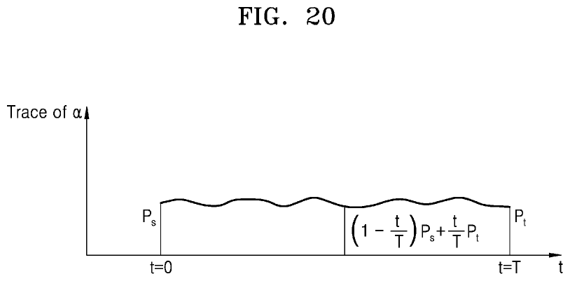

The changing trend of the value α (α=interpolationt) of the training phase integration function is shown in FIG. 20. From the integration function, when t=0, that is, when the expert second indication information of the first word is calculated, the integration function is biased to directly utilize the sentence-level expert second indication information. When t=T, that is, when the expert second indication information of the T^{th} word is calculated, the integration function is biased to directly utilize the word-level expert second indication information; when 0<t<T, the integration function simultaneously considers the sentence-level expert second indication information and the word-level expert second indication information as the final expert second indication information.

During the training phase, the acquiring of the target decoded features may refer to the processes of operations S1 to S2.

In one or more examples, after the electronic device trains the data distribution prediction module, the electronic device may also construct a prototype database stored by the expert selector by using the trained encoder, decoder, and the data distribution prediction module. In one or more examples, the prototype database construction method may include the following operations E1 to E3:

In operation E1, the electronic device translates the individual third data in the third dataset into corresponding individual fourth data based on the trained encoder and decoder, and acquires a decoded hidden state vector corresponding to each data segment in each fourth data, to obtain a set of decoded hidden state vectors.

In one or more examples, the decoded hidden state vector corresponding to each data segment is the decoded hidden state vector used in translating and outputting the data segment. For example, for each third data, when translating its corresponding fourth data, the translation process for each data segment in the fourth data may include: the electronic device may decode, by the trained decoder, the feature vector of the first data segment which has been translated and output and the encoded hidden state vector of the third data to obtain a decoded hidden state vector corresponding to the data segment, and translate and output the corresponding data segment based on the decoded hidden state vector. Thus, the electronic device may acquire the decoded hidden state vector used in translating and outputting each data segment.

In operation E2, the electronic device constructs, based on the trained data distribution prediction module, a mapping relationship between the domain and the expert module, and determines the expert module corresponding to each decoded hidden state vector in the decoded hidden state vector set based on the mapping relationship and the domain tag of each data segment in each fourth data.

When the data distribution prediction module is trained, datasets from various domains may be used and clustered, to obtain the data distribution category of each data, while each data distribution category may correspond to expert modules (e.g., 12 data distribution categories correspond to 12 expert modules, such as the IT domain mapping to expert 1 and expert 2). For example, for the case where one domain may correspond to a plurality of experts, such as the IT domain, the domain words are randomly mapped to their corresponding experts, such as the words k-means belonging to the IT domain, the experts corresponding to the IT domain are expert 1 and expert 2, at which time the k-means will be tagged as the corresponding expert 1 with a probability of 50%, and will be tagged as the corresponding expert 2 with a probability of 50%. Thus, the electronic device may determine a data distribution category corresponding to the data segment based on the domain tag of each data segment, to obtain an expert module corresponding to the data segment, thereby building a large number of decoded hidden states corresponding to each expert module.

In operation E3, the electronic device determines a hidden state center point of each expert module based on the decoded hidden state vector corresponding to each expert module.

For example, for a plurality of decoded hidden state vectors corresponding to each expert module, the electronic device may cluster the plurality of decoded hidden state vectors to obtain a hidden state center point of the expert module. Each expert module may correspond to one or more hidden state center points.

As shown in FIG. 21, the prototype database construction flow may be performed in accordance with operation 1 to operation 3:

In operation 1, the domain corresponding to the word on the decoding end of the dataset is tagged;

In operation 2, for a word in a certain tagged domain, the decoded hidden state vector q=f(x, y_{1:i-1}) for predicting the word as the same domain as this word is tagged. For example, x refers to the input sentence at the encoding end, and y_{1:i-1} refers to the decoded hidden state vectors corresponding to the words from the first word to the (i−1)^{th} word output at the decoding end.

In operation 3, after collecting enough of the decoded hidden state vectors, may determine a set of decoded hidden states corresponding to each expert module based on a correspondence between the domain built by the data distribution prediction module and the expert module, calculate a center point of each expert module, and store to the prototype database.

In operation 1803_c, the electronic device acquires, based on the expert module corresponding to each data, the translation result corresponding to each data in the training dataset.

In this operation, the electronic device may obtain the translation result by directly using the expert module corresponding to the data; or, may further obtain the expert module corresponding to each target segment of the translation result output sequence, and obtain the corresponding target segment by using the expert module corresponding to each target segment. For example, the data may be a Chinese sentence, the translation result may be a corresponding English sentence, and the target segment may be each English word included in the English sentence. In one or more examples, the electronic device may acquire the translation result by directly using the sentence-level expert module. In one or more examples, the electronic device may also determine a word-level expert module corresponding to each English word in the output sequence of the English sentence, and acquire the translation result by using each word-level expert module.

In one or more examples, operation 1803_c may include the following two manners.

In manner 1, the electronic device may obtain the translation result by directly using the expert module corresponding to the data. The execution of the process may be similar to the process of operation 203_a.

In manner 2, the expert module corresponding to each data includes an expert module corresponding to each target segment. The execution of the process may be similar to the process of operation 2032.

In operation 1803_d, the electronic device trains each candidate domain adapter based on the translation truth value dataset of the training dataset and the translation result.

In one or more examples, the training loss may be calculated based on the translation truth value dataset of the training dataset and the translation results, and each candidate domain adapters may be iteratively trained based on the training loss, to obtain the trained individual candidate domain adapters, thereby ultimately obtaining the trained machine translation model.

In one or more embodiments, there is provided a training process for a codec module, in one or more examples, the electronic device may acquire a sample dataset, input a sample dataset into an encoder, obtain the encoded hidden state vector of a sample dataset, and decode the encoded hidden state vector of the sample dataset by the decoder, to obtain the decoded hidden state vector. The electronic device may further obtain a translation result of the sample dataset based on the decoded hidden state vector and train a codec module. The sample dataset may include a source dataset to be translated and a translation truth value dataset corresponding to the source dataset. For example, a bilingual parallel corpus from different sources may constitute a sample dataset used when training the codec module. For example, the sample dataset S^{T} may be denoted as S^{T}=Σᵢ₌₁^{N} λᵢSᵢ; where, i represents the i^{th} source corpus, Sᵢ represents the data feature distribution of the i^{th} source corpus; λᵢ represents the corresponding mixed weights of the i^{th} source corpus in the plurality of corpora. In one or more examples, if multiple corpuses are randomly mixed, λᵢ may be proportional to the data size of the corresponding i^{th} source corpus. In one or more examples, if the electronic device receives a translation request x=(x₁, . . . , xₙ), x may be first converted into the encoded hidden state h=(h₁, . . . , hₙ) by the encoder, and then the encoded hidden state vector h may be passed through the decoder, to obtain a final output result y=(y₁, . . . , yₘ) by means of a self-looping decoder.

The decoded hidden state of the decoder may be used by an expert selector to score the word-level expert module for each translation output at the output. This score may then be integrated with the sentence-level expert module scores calculated by the data distribution prediction module. Finally, the appropriate word-level expert modules may be dynamically allocated for translation requests based on the overall scoring. For example, the expert selector module may implement a token level expert selection strategy where each output may be assigned to a different expert (e.g., each word may have a different token-level expert module). In particular, when the expert selector scores by using only the sentence-level expert modules obtained by the data distribution prediction module, its expert selection strategy may degenerate to a sentence-level strategy (each output is assigned the same sentence-level expert module).

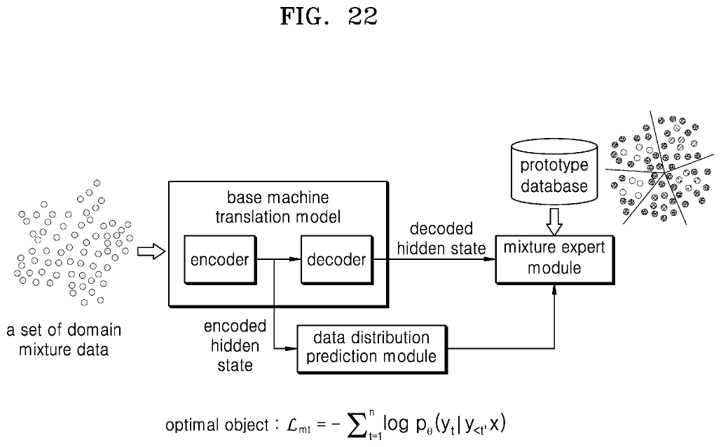

As shown in FIG. 22, at the training phase of the mixture expert module, the mixture expert module may be trained by using the following Equation 14, based on a domain-mixed machine translation dataset with an optimization goal for the machine translation task:

[symbol]

ₘₜ=Σₜ₌₁ⁿ log p_{θ}(yₜ|y_{<t},x); Equation 14:

Where, p_{θ} refers to all of the trainable parameters in the network, for example, which may include the trainable parameters of the mixture expert module, yₜ refers to the translation output of the t^{th} operation, y_{<t} refers to all of the outputs before the t^{th} operation. For example, yₜ refers to the t^{th} English word currently to be translated and output, y_{<t} refers to the first (t−1)^{th} English word which have been translated and output previously; x refers to the translation input, for example a Chinese sentence; n refers to the total length or operation translated and output, for example, the total number of words of the corresponding English sentence.

In one or more embodiments, after the trained machine translation model may be obtained based on the model training method of operations 1801-1803 described above, when there is a data update in a certain training set, such as a newly collected batch of data, the model's training cost and update cost may be reduced in a partially updated manner. The device to be updated may be an electronic device performing the processes of operations 1401-1403.

In one or more examples, after operation 1803, the model may be partially updated and trained and the relevant model parameters of the device on which the model is deployed may be updated by performing the following operations (1) to (3).

In operation (1), the electronic device acquires, based on the trained data distribution prediction module, a first category corresponding to the updated dataset in the at least one data distribution category.

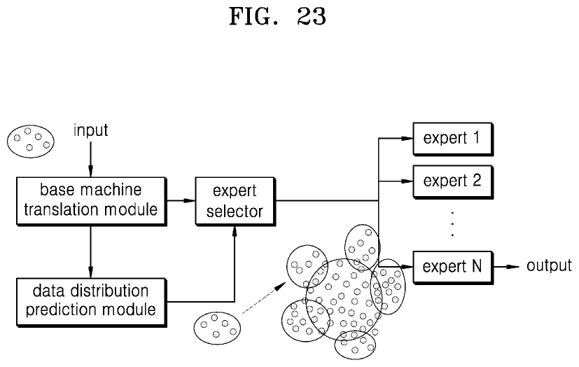

The electronic device may perform a data distribution prediction on the updated dataset by a data distribution prediction module, to obtain a prediction result of the updated dataset, and based on the prediction result; the prediction result may characterize a data distribution category of each data in the updated dataset; the electronic device may determine, based on the prediction result, a category of the at least one data distribution category that conforms to a most relevant condition as the first category. In one or more examples, the most relevant condition may include that the volume of data in the updated dataset that belongs to the data distribution category exceeds a first data volume threshold. For example, as shown in FIG. 23, a base machine translation module and a data distribution prediction module including an encoder and a decoder are fixed; the encoded hidden state vector may be acquired by the base machine translation model and is input to the data distribution prediction module, to obtain a first category of the updated dataset, and when more than 90% of the data in the updated dataset A belongs to category 1 and category 2 in the 12 data distribution categories, the remaining 10% of the data may be distributed in the remaining categories 3 to 12, and category 1 and category 2, to which 90% of the data belong, may be used as the most relevant first category of the updated dataset.

In operation (2), the electronic device trains a first expert module corresponding to the first category in the mixture expert module to obtain third updated data based on the trained data distribution module and the updated dataset.

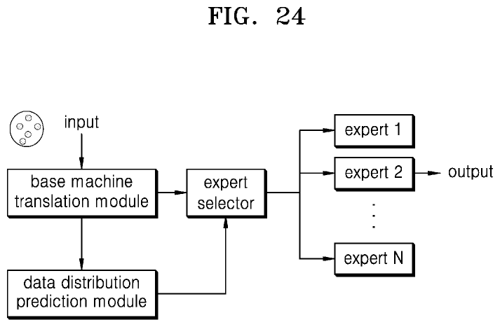

The electronic device may determine a first expert module corresponding to the first category based on a correspondence between the data distribution category and the expert module, and fixes network parameters of the trained data distribution prediction module and the codec module, trains the first expert module based on the updated dataset, and acquires the third updated data of the trained first expert module, which may include model parameters of the trained first expert module. As shown in FIG. 24, the first category of the updated dataset is category 2, corresponding to expert 2, and the expert 2 may be trained to obtain the third updated data corresponding to the trained expert 2.

In operation (3), the electronic device may send the third updated data to the device to be updated to cause the device to be updated to update the first expert module based on the third updated data.

In one or more examples, the device to be updated is a device on which the machine translation module is deployed, and only the model parameters of the first expert module may be sent to the device to be updated when the user updates the model offline. The device to be updated updates the model parameters of the first expert module to the third updated data.

When there is an update to a dataset in a certain domain, the first category most relevant to the updated dataset may be first found by the operations (1) to (3) described above to obtain the most relevant first expert module. Subsequently, model parameters of the codec module and the data distribution prediction module may be fixed, and only the most relevant first expert module in the mixture expert module is trained, enabling training of the specified module according to the category of the dataset, greatly reducing the training cost. While enabling decoupling between the individual expert modules, training only the most relevant first expert module, there is no translation quality impact on the rest of the unrelated expert modules, avoiding the performance regression of translation quality for the rest of the expert modules and the rest of the domain in the related technology.

Moreover, during the user's offline model update phase, only the model parameters of the first expert module are sent to the device to be updated, which greatly reduces the network consumption cost, lowers the update cost for the user, and improves the practicality of model training.

In one or more embodiments, after the trained machine translation model may be obtained based on the model training method of operations 1801-1803 above, when a dataset of a data category is newly added, an additional expert module may need to be applied for the dataset of the newly added category. In one or more examples, after operation 1803, the model may be partially updated and trained by performing operations (4) to (7) below, and the relevant model parameters for device where the model is deployed is updated.

In operation (4), the electronic device trains the data distribution prediction module to obtain the first updated data based on the target dataset and the dataset of the newly added category.

The newly added category is different from the data distribution category of any data in the target dataset. In one or more examples, if the number of data distribution categories of the current data distribution prediction module is N, the newly added category may be tagged as N+1, and the dataset of the newly added category is added to the constructed target dataset of the data distribution prediction module, to obtain an updated target dataset. The electronic device may retrain, based on the updated target dataset, the data distribution prediction module to obtain first updated data, where the first updated data includes model parameters of the trained data distribution prediction module.

It should be noted that, since supervised training is employed, the training results are controllable, so training of the data distribution category may be equivalent to adding a data distribution category (e.g., the number of data distribution categories is changed from N to N+1), and the impact on the prediction capability of the data distribution prediction module for data distribution categories from 1 to N is small and may be ignored.

In operation (5), the electronic device adds a second expert module corresponding to the newly added category in the mixture expert module.

The electronic device may add a second expert module in the mixture expert module and establishes a correspondence between the second expert module and the newly added category.

In operation (6), the electronic device trains the second expert module to obtain the second updated data based on the dataset of the newly added category.

The electronic device may fix the network parameters of the trained data distribution prediction module and the codec module, train the second expert module based on the dataset of the newly added category, and acquire the second updated data of the trained second expert module, the second updated data may include model parameters of the trained second expert module.

In operation (7), the electronic device may send the first updated data and the second updated data to the device to be updated to cause the device to be updated to update the data distribution prediction module based on the first updated data and add a second expert module in the machine translation model based on the second updated data.

In one or more examples, when a user updates a model offline, only the model parameters of the second expert module and the model parameters of the data distribution prediction module may be sent to the device to be updated. The device to be updated updates the model parameters of the data distribution prediction module to the first updated data and may add a second expert module in the machine translation model based on the second updated data.

In one or more examples, the electronic device may acquire a set of decoded hidden state vectors of the datasets of the newly added category, and update the prototype database based thereon, and may also update an expert selector local to the device to be updated. The process may include the following operations F1 to F3:

In operation F1, the electronic device acquires a set of decoded hidden state vectors corresponding to the datasets of the newly added category;

In operation F2, the electronic device determines, based on the set of decoded hidden state vectors, a hidden state center point of the second expert module, and updates the hidden state center point of the second expert module to the prototype database;

In operation F3, the electronic device sends the fourth updated data to the device to be updated to cause the device to be updated to update the prototype database in the expert selector based on the fourth updated data.

For example, the set of decoded hidden state vectors corresponding to the newly added category includes the decoded hidden state vectors corresponding to the data segment of each data in the dataset. Furthermore, the electronic device may also send the fourth updated data to the device to be updated, the fourth updated data may include a hidden state center point of the second expert module to cause the device to be updated to update the locally stored expert selector based on the fourth updated data, for example, update the prototype database in the expert selector.

In the model maintenance phase, when a new domain or the datasets of newly added category is collected, then a new domain or category needs to be added along with its corresponding expert module. One example update procedure is as follows:

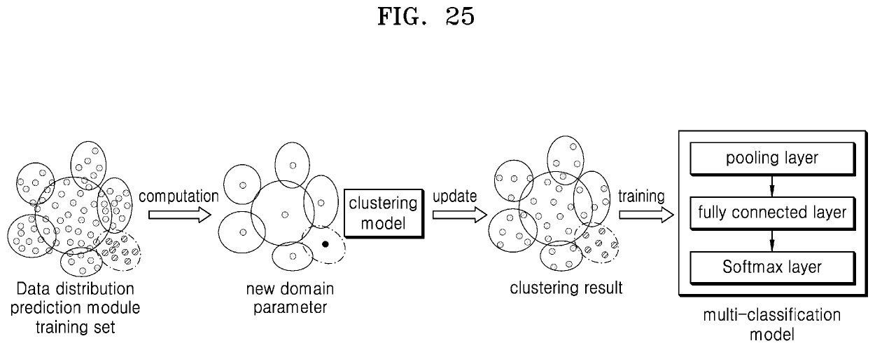

As shown in FIG. 25, for the update of the data distribution prediction module, including: operation 1, adding a new domain or the datasets of newly added category to the training set of the data distribution prediction module; operation 2, computing parameters of the data distribution prediction module in the new domain. For example, when the data distribution prediction module uses k-means clustering, this parameter refers to a category center point. For example, when a Gaussian Mixture Model (GMM) may be used, this parameter refers to a Gaussian parameter of the category. Operation 3, updating the clustering results, for example, updating the data distribution category. Operation 4: retraining the data distribution prediction module based on the updated clustering results, for example, retraining the multi-classification model of the data distribution category used to acquire data in the data distribution prediction module. The multi-classification model may comprise a pooling layer, a fully connected layer and a softmax layer.

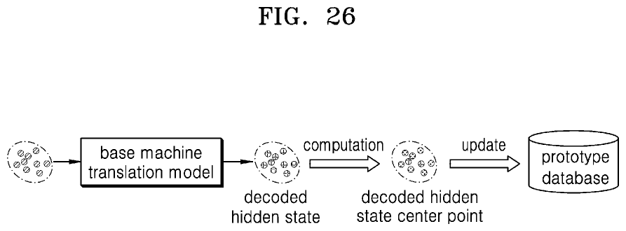

As shown in FIG. 26, the update of the prototype database may include: computing a set of decoded hidden state vectors corresponding to a dataset of the newly added category or a new domain; and computing a hidden state center point of the newly added second expert module based on the set of decoded hidden state vectors of the dataset and updating the hidden state center point of the second expert module into the prototype database.

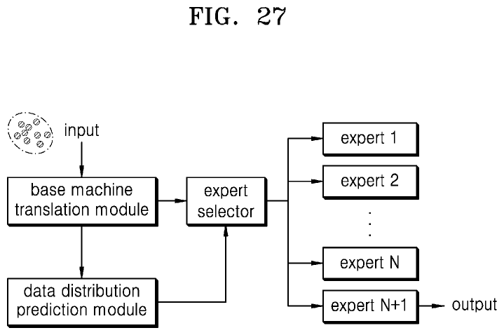

As shown in FIG. 27, for the dataset of the newly added category, the data distribution prediction module may be first trained by operations (4) to (7) described above. The data distribution prediction module may apply for an additional expert module in the mixture expert module, and record as the second expert module corresponding to N+1 categories, such as expert N+1, initialize the parameters for the newly added second expert module, and use the dataset of the newly added category to train the second expert module separately, which greatly reduces the training cost and improves the training efficiency. Furthermore, due to the decoupling between each expert module, there is no impact on the translation quality of the remaining expert modules except the second expert module, avoiding the performance regression of translation quality for the rest of the expert modules and the rest of the domain in the related technology.

Moreover, in the user's offline model update phase, only the model parameters of the newly added expert module and the model data of the data distribution prediction module are sent to the device to be updated, and only the data distribution prediction module and the newly added expert module are updated on the user's device, which greatly reduces the network consumption cost, lowers the update cost of the user, and improves the practicality of model training. Moreover, the present disclosure further proposes expert modules corresponding to target segments, for example, for sentence-level translation requests, and further provides word-level expert selection strategies, thereby effectively coping with the situation where a translation request contains multiple domains, further improving the quality of multi-domain machine translation.

Based on the model training method proposed in the present disclosure, the training of the machine translation models based on decoupled mixture expert architecture reduces the training cost and update cost, solves the problem of poor quality of multi-domain machine translation, and it is easier to train and update some modules compared with traditional mixture expert models. Compared with other models shows that the model obtained by using the model training method of the present disclosure may significantly improve the quality of domain translation; compared with the results without domain data shows that the model obtained by using the model training method of the present disclosure may improve the quality of domain translation to a small extent even in the absence of domain data.

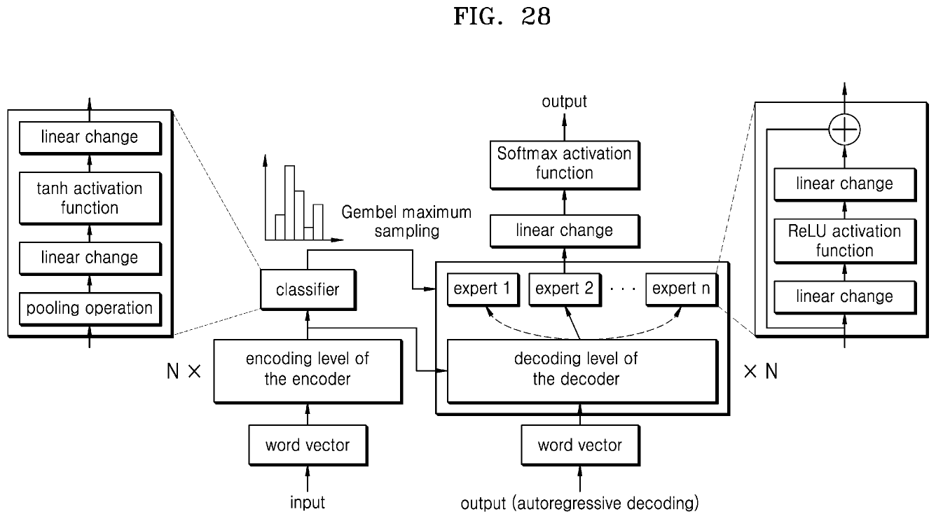

FIG. 28 is a schematic diagram of a network structure of a machine translation model provided by the present disclosure. As shown in FIG. 28, the machine translation model may be a model based on a decoupled mixture expert architecture. The machine translation model may include: a codec module, a data distribution prediction module, and a mixture expert module. The data distribution prediction module may be a classifier as shown in FIG. 28. The data distribution prediction module may be a module independent of the decoder and trained independently, and the data distribution prediction module may be used to determine the data distribution category of the input data. The mixture expert module may include n expert modules such as expert 1, expert 2, . . . expert n, etc. The codec module may include an encoder and a decoder, with the encoder being used for semantic feature extraction of the input data, and the decoder being used for decoding the encoded features.

The encoder and decoder may each include several levels. For example, for the encoder, a word vector of the information to be translated is input, an encoded hidden state vector may be obtained by an encoding level of the encoder. The encoded hidden state vector is input a classifier to obtain a data distribution category of the information to be translated, and an expert module corresponding to the information to be translated may be obtained based on the data distribution category. In the present disclosure, there is a one-to-one correspondence between the data distribution category and the expert module. The encoded hidden state vector may be sequentially subjected to a pooling operation, a linear transformation, a tan h activation function activation operation and a linear change based on each decoding level of the classifier to obtain the data distribution category of the information to be translated. When training the mixture expert module, noise may also be added to the probability vector of each data distribution category based on the data, for example, by adding Gembel noise to the probability vector by means of Gembel maximum sampling to improve the translation quality of each trained experts.

The input of the decoder is the encoded hidden state vector output by the encoder. The decoder includes N decoding levels, the mixture expert module may be provided at the end of each decoding level of the decoder to provide corresponding expert module for each data category respectively, to process the decoded hidden state vector output from each decoding level by using the corresponding expert module. For example, for any decoding level in the decoder, the encoded hidden state vector output from the previous decoding level may be decoded by this decoding level to obtain a first decoded hidden state vector, and this first decoded hidden state vector is processed by the expert module corresponding to the information to be translated among the N expert modules (e.g. expert 2), to obtain a second decoded hidden state vector, and the second decoded hidden state vector is input into the next decoding level of the decoder, and the same operations as this decoding level may be repeated at the next decoding level until the final decoded hidden state vector is obtained based on the last decoding level and the corresponding expert module. The decoder may decode the input data in an autoregressive decoding manner. For each expert module, the first decoded hidden state vector may be sequentially subjected to a series of processes such as linear change, ReLU activation function processing, linear change, etc. based on the feedforward neural network inside the expert module, and the first decoded hidden state may be combined with the first decoded hidden state after the series of processes in a summation manner to obtain the second decoded hidden state vector. Finally, the final decoded hidden state vector is linearly changed and may be processed by the Softmax activation function to obtain the translation result of the information to be translated.

The model training method provided by the present disclosure, acquires the dataset tags of the target dataset and trains the data distribution prediction module based on this target dataset and the dataset tags to realize supervised training of the data distribution prediction module based on the target dataset with the dataset tags so that the training result of the data distribution prediction module are controllable for providing the likelihood of decoupling between each module. The method then trains the mixture expert module based on the trained data distribution prediction module, and decomposes the training process of each module under the premise of guaranteeing the translation quality of the machine translation modules obtained from the training. Each module may be trained independently to realize the decoupling between each module, thereby reducing the model training cost, reducing the model update cost of the model deployment equipment, and improving the practicality of the model training process.

According to one or more embodiments of the present disclosure, in a method performed by an electronic device, a machine translation method for recognizing user speech and interpreting user intent may receive a speech signal as an analog signal via a speech capture device (e.g., a microphone) and convert the speech portion to a computer readable text by using an automatic speech recognition (ASR) model. The user's utterance intent may be obtained by interpreting the converted text by using a natural language understanding (NLU) model. The ASR model or NLU model may be an artificial intelligence model. The artificial intelligence model may be processed by an artificial intelligence special purpose processor designed in the hardware structure specified for the artificial intelligence model. The artificial intelligence model may be obtained by training. Here, “obtaining by training” may correspond to training a basic artificial intelligence model with a plurality of training data through a training algorithm to obtain predefined operating rules or artificial intelligence models that are configured to perform the desired features or purposes. The artificial intelligence model may include a plurality of neural network layers. Each of the plurality of neural network layers may include a plurality of weight values, and the neural network computation may be performed by the computation result of the previous layer and the computation between the plurality of weight values.

Language understanding is a technique for recognizing and applying/processing human language/text, including, for example, natural language processing, machine translation, dialog system, question answering, or speech recognition/synthesis.

The apparatus provided in the one or more embodiments of the present disclosure may implement at least one of the plurality of modules through an AI model. The functions associated with the AI may be performed by non-volatile memory, volatile memory, and a processor.

The processor may include one or more processors. At this time, the one or more processors may be general-purpose processors such as a central processing unit (CPU), application processor (AP), etc., or a pure graphics processing unit, such as a graphics processing unit (GPU), a visual processing unit (VPU), and/or an AI specialized processor, such as a Neural processing unit (NPU).

The one or more processors control the processing of the input data according to predefined operating rules or artificial intelligence (AI) models stored in the non-volatile memory and the volatile memory. The predefined operating rules or artificial intelligence models are provided by training or learning.

Providing, by learning, may refer to deriving a predefined operating rule or an AI model having a desired characteristic by applying a learning algorithm to the plurality of learning data. The learning may be performed in the apparatus itself in which the AI according to the embodiments is performed, and/or may be implemented by a separate server/system.

The AI model may include a plurality of neural network layers. Each layer has a plurality of weight values, and the computation of one layer is performed by the computation result of the previous layer and the plurality of weights of the current layer. Examples of neural networks include, but are not limited to, a convolutional neural network (CNN), a deep neural network (DNN), a recurrent neural network (RNN), a restricted Boltzmann machine (RBM), a deep belief network (DBN), a bi-directional recurrent deep neural network (BRDNN), generative adversarial networks (GAN), and deep Q-networks.

The learning algorithm is a method of training a predetermined target device (e.g., a robot) by using a plurality of learning data to enable, allow, or control the target device to make a determination or prediction. Examples of the learning algorithm include, but are not limited to, supervised learning, unsupervised learning, semi-supervised learning, or reinforcement learning.

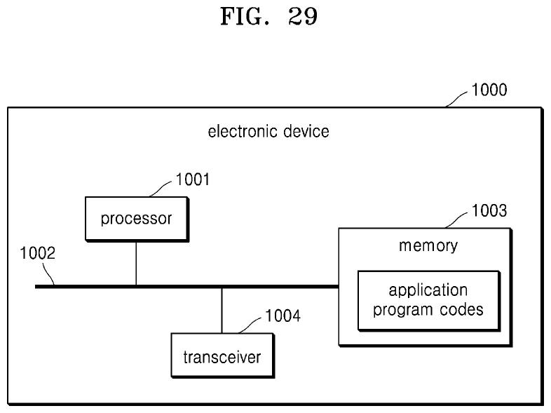

FIG. 29 is a schematic structural diagram of an electronic device provided by one or more embodiments of the present disclosure. As shown in FIG. 29, the electronic device may include a memory and a processor, and at least one program stored in the memory for execution by the processor when compared to the prior art enabling the method described above to be performed by the electronic device.

In one or more embodiments, an electronic device is provided, as shown in FIG. 29. The electronic device 1000 shown in FIG. 29 may include a processor 1001 and a memory 1003. The processor 1001 and the memory 1003 may be connected, for example, by a bus 1002. The electronic device 1000 may also include a transceiver 1004 that may be used for data interactions between the electronic device and other electronic devices, such as transmission of data and/or reception of data. The transceiver 1004 in an actual application is not limited to one, and the structure of the electronic device 1000 does not constitute a limitation of the embodiments of the present disclosure.

The processor 1001 may be a Central Processing Unit (CPU), a general-purpose processor, a Digital Signal Processor (DSP), an Application Specific Integrated Circuit (ASIC), a Field Programmable Gate Array (FPGA), or other programmable logic device, transistor logic device, hardware components, or any combination thereof. It may implement or perform the various illustrative logical blocks, modules, and circuits described in connection with the disclosure herein. The processor 1001 may also be a combination of computing functions, including, for example, one or more microprocessor combinations, a combination of a DSP and a microprocessor, or any other combination of processing circuits known to one of ordinary skill in the art.

The bus 1002 may include a pathway to transmit information between the above components. The bus 1002 may be a Peripheral Component Interconnect (PCI) bus or an Extended Industry Standard Architecture (EISA) bus, or any other bus structure known to one of ordinary skill in the art. The bus 1002 may be classified into an address bus, a data bus, a control bus, or the like. For ease of representation, the bus in FIG. 29 is represented by a single thick line, but it does not mean that there is only one bus or one type of bus.

The memory 1003 may be a Read Only Memory (ROM) or other type of static storage device that may store static information and instructions, a Random Access Memory (RAM) or other type of dynamic storage device that may store information and instructions, may also be an Electrically Erasable Programmable Read Only Memory (EEPROM), a Compact Disc Read Only Memory (CD-ROM) or other optical disk storage, an optical disk storage (including compact discs, laser discs, optical discs, digital versatile discs, Blu-ray discs, etc.), magnetic disk storage media or other magnetic storage devices, or any other medium that may be used to carry or store desired program code in the form of instructions or data structures and that may be accessed by a computer, but is not limited to such.

The memory 1003 may be used to store the application program code (computer program) for executing solution of the present disclosure and is controlled for execution by processor 1001. The processor 1001 may be used to execute the application program code stored in the memory 1003 to implement what is shown in the preceding method embodiment.

Wherein, the electronic device includes, but is not limited to: a server, a serving cluster, a terminal, or the like.

Embodiments of the present disclosure provide a computer-readable storage medium on which a computer program is stored that, when run on the computer, enables the computer to execute the corresponding content of the machine translation method, and the model training method, of the preceding method embodiments.

Embodiments of the present disclosure provide a computer program product or computer program comprising computer instructions, the computer instructions being stored in a computer readable storage medium. A processor of an electronic device reads the computer instructions from a computer-readable storage medium, the processor executing the computer instructions, causing the electronic device to perform the machine translation method and model training method described above.

The terms “first,” “second,” “third,” “fourth,” “1,” “2,” etc. in the specification, claims and the above accompanying drawings of the present disclosure, if any, are used to distinguish similar objects and are not necessarily used to describe a particular order or sequential order. It should be understood that the data so used are interchangeable where appropriate so that the embodiments of the present disclosure described herein may be implemented in an order other than that illustrated or described in the text.

It should be understood that, although the various operations in the flow diagrams of the figures are shown in turn in the order of arrows, these operations are not necessarily performed in the order indicated by the arrows. The performance of these operations is not limited by the exact order unless expressly stated herein, which may be performed in other sequences. Also, at least a portion of the operations in the flowcharts of the accompanying drawings may include a plurality of sub-operations or stages, which are not necessarily performed at the same time, but may be performed at different times, the order of execution thereof is not necessarily performed in sequence, but may be performed in turn or alternatively with at least a portion of the sub-operations or stages of other operations or other operations.

The above are only a portion of embodiments of the invention. It should be noted that for those skilled in the art, a number of improvements and embellishments may be made without departing from the principles of the invention, and these improvements and embellishments should also be considered as the scope of protection of the invention.

According to one or more embodiments, a method performed by an electronic device, comprises: acquiring information to be translated; determining, based on the information to be translated, a target domain adapter from a plurality of candidate domain adapters, the target domain adapter corresponding to the information to be translated, each candidate domain adapter from the plurality of candidate domain adapters corresponding to at least one domain; and obtaining, based on the target domain adapter corresponding to the information to be translated, a translation result corresponding to the information to be translated.

According to one or more embodiments, the determining the target domain adapter from the plurality of candidate domain adapters comprises: acquiring a first encoded feature of the information to be translated; determining, according to the first encoded feature, first indication information of the information to be translated, wherein the first indication information characterizes a likelihood that each candidate domain adapter is the target domain adapter; and determining, according to the first indication information, the target domain adapter corresponding to the information to be translated from the plurality of candidate domain adapters.

The determining the target domain adapter from the plurality of candidate domain adapters comprises: acquiring a first encoded feature of the information to be translated; obtaining, based on the first encoded feature, a segment decoded feature of each target segment corresponding to the information to be translated; obtaining, based on the segment decoded feature of each target segment, second indication information of the target segment; and determining the target domain adapter of the target segment based on the second indication information of the target segment, wherein the second indication information of each target segment characterizes the likelihood that each candidate domain adapter is the target domain adapter of the target segment, wherein the obtaining the translation result corresponding to the information to be translated, comprises: for each target segment, outputting, based on the segment decoded feature of the target segment and by the target domain adapter corresponding to the target segment, a respective translation result of the target segment.

The obtaining the second indication information of the target segment, and the determining the target domain adapter of the target segment based on the second indication information of the target segment, comprises: for each target segment, determining, based on a segment decoded feature of a respective target segment at a first decoding level, second indication information of the respective target segment; and determining, based on the second indication information corresponding to the respective target segment at the first decoding level, a target domain adapter corresponding to the respective target segment at each decoding level.

The obtaining, based on the segment decoded feature of each target segment, the second indication information of the target segment, and determining the target domain adapter of the target segment based on the second indication information of the target segment, comprise: for each target segment, determining, according to a segment decoded feature of the target segment at each decoding level, a second indication information corresponding to a respective target segment at a respective decoding level, and determining, according to the second indication information corresponding to the respective target segment at the respective decoding level, a target domain adapter corresponding to the respective target segment at the respective decoding level, wherein the second indication information corresponding to the respective target segment at the respective decoding level characterizes a likelihood that each candidate domain adapter is the target domain adapter corresponding to the respective target segment at the respective decoding level.

The determining, according to the second indication information corresponding to the respective target segment at the respective decoding level, the target domain adapter corresponding to the respective target segment at the respective decoding level comprises: determining, according to the second indication information corresponding to the respective target segment at the respective decoding level, the target domain adapter corresponding to the respective target segment at the respective decoding level from each candidate adapters corresponding to the respective decoding levels.

The method of outputting, based on the segment decoded feature of the target segment and by the target domain adapter corresponding to the target segment, a translation result of each target segment comprises: for each decoding level, converting, according to the segment decoded feature of the respective target segment at the respective decoding level and via the target domain adapter corresponding to the respective target segment at the respective decoding level to obtain the converted segment decoded feature, and outputting the converted segment decoded feature; and outputting the translation result of the respective target segment according to the converted segment decoded feature output by the last decoding level. The determining, according to the second indication information corresponding to the respective target segment at the respective decoding level, the target domain adapter corresponding to the respective target segment at the respective decoding level comprises: determining, according to the second indication information corresponding to the respective target segment at the respective decoding level, the target domain adapter corresponding to the respective target segment at the respective decoding level from each candidate adapters corresponding to the respective decoding levels.

The outputting, based on the segment decoded feature of the target segment and by the target domain adapter corresponding to the target segment, a translation result of each target segment comprises: for each decoding level, converting, according to the segment decoded feature of the respective target segment at the respective decoding level and via the target domain adapter corresponding to the respective target segment at the respective decoding level to obtain the converted segment decoded feature, and outputting the converted segment decoded feature; and outputting the translation result of the respective target segment according to the converted segment decoded feature output by the last decoding level.

The method further comprising: for each target segment, acquiring the decoded feature of the respective target segment at each decoding level by: for a first decoding level, obtaining a segment decoded feature of the target segment at the first decoding level, based on the first encoded feature and a second encoded feature of a translated segment prior to the target segment; and for a second decoding level, obtaining a segment decoded feature of the target segment at the second decoding level, based on the first encoded feature and a converted segment decoded feature outputted by the target segment at the previous decoding level, and wherein the first decoding level is a first decoding level of at least two decoding levels, and the second decoding level is any decoding level other than the first decoding level.

The method further comprising: determining the first indication information of the information to be translated according to the first encoded feature of the information to be translated; wherein the determining the target domain adapter of the target segment based on the second indication information of the target segment comprises: for each target segment, determining the target domain adapter of the respective target segment according to the second indication information of the respective target segment and the first indication information.

The determining the target domain adapter of the target segment according to the second indication information of the target segment and the first indication information comprises: acquiring a first weight corresponding to the first indication information and a second weight corresponding to the second indication information; weighting the first indication information and the second indication information based on the first weight and the second weight, respectively, to obtain third indication information; and determining the target domain adapter of the target segment based on the third indication information.

The acquiring the first weight corresponding to the first indication information and the second weight corresponding to the second indication information comprises: for each target segment, determining the second weight based on a bit-order of the respective target segment, and obtaining the first weight based on the second weight; wherein a second weight corresponding to one target segment is positively correlated to the bit-order.

The obtaining the second indication information of the target segment based on the segment decoded feature of each target segment comprises: for each target segment, obtaining the second indication information of the target segment based on a similarity between the segment decoded feature of the target segment and a domain feature vector of each candidate domain adapter.

The obtaining the second indication information of the target segment based on the segment decoded features of each target segment comprises: for each target segment, determining second indication information of the respective target segment, based on the segment decoded feature of the respective target segment, and a segment decoded feature of the translated segment prior to the respective target segment.

The method comprising: displaying a list of translation domains, the list of translation domains comprising identification information of at least one candidate translation domain of a plurality of candidate translation domains; acquiring a first input of a user, the first input for selecting a domain corresponding to translation from the list of translation domains; and in response to the first input, downloading a domain adapter of the corresponding domain.

The method further comprising: displaying update prompt information, the update prompt information for prompting an update to the domain corresponding to translation; and in response to the acquired update indication, updating the domain adapter of the respective domain.

A method performed by an electronic device, comprising: displaying a list of translation domains, the list of translation domains comprising identification information of at least one candidate translation domain of a plurality of candidate translation domains; acquiring a first input of a user, the first input for selecting a translation domain from the list of translation domains; in response to the first input, downloading a domain adapter of the corresponding domain.

The method further comprising: displaying update prompt information, the update prompt information for prompting an update to the selected translation domain corresponding to translation; in response to the acquired update indication, updating a domain adapter of the respective domain.

A method performed by an electronic device, comprising: acquiring a dataset tag of a target dataset, the dataset tag characterizing a data distribution category of each data in the target dataset; training a data distribution prediction module based on the target dataset and the dataset tag, the data distribution prediction module for predicting a probability that each data in the target dataset belongs to respective data distribution categories, wherein each data distribution category corresponds to at least one domain; and based on the trained data distribution prediction module, training each candidate domain adapter to obtain a machine translation model, wherein each candidate domain adapter corresponds to at least one domain.

The target dataset comprises at least a first dataset obtained by sampling a source dataset to be translated; the acquiring a dataset tag of the target dataset comprises: acquiring a first encoded feature of the respective first data in the first dataset based on the trained encoder; and classifying the respective first data based on the first encoded feature of the respective first data, and obtaining the dataset tag of the target dataset.

The training each candidate domain adapter based on the trained data distribution prediction module comprises: acquiring a prediction result of a training dataset based on the trained data distribution prediction module; determining, based on the prediction result of the training dataset, the target domain adapter corresponding to each data in the training dataset in the respective candidate domain adapters; acquiring a translation result corresponding to each data in the training dataset based on the target domain adapter corresponding to the each data; and training the respective candidate domain adapter based on the translation result.

After training the respective candidate domain adapter based on the trained data distribution prediction module, the method further comprising: training the data distribution prediction module based on the target dataset and the datasets of the newly added category, to obtain first updated data, wherein the newly added category is different from the data distribution category of any data in the target datasets; adding a domain adapter corresponding to the newly added category in the respective candidate domain adapter; training the first domain adapter to obtain a second updated data based on the datasets of the newly added category; transmitting the first updated data and the second updated data to a device to be updated to cause the device to be updated to update the data distribution prediction module based on the first updated data, and to add the first domain adapter in a machine translation model based on the second updated data.

An electronic device, comprising one or more processors (1001); a memory (1003); one or more computer programs, wherein the one or more computer programs are stored in the memory (1003) and configured to be executed by the one or more processors (1001), the one or more computer programs configured to: perform the methods described above.

A computer-readable storage medium for storing computer instructions that, when executed on a computer, enable a computer to perform the methods described above.

What is claimed is:

1. A method performed by an electronic device, the method comprising:
acquiring information to be translated;
determining, based on the information to be translated, a target domain adapter from a plurality of candidate domain adapters, the target domain adapter corresponding to the information to be translated, each candidate domain adapter from the plurality of candidate domain adapters corresponding to at least one domain; and
obtaining, based on the target domain adapter corresponding to the information to be translated, a translation result corresponding to the information to be translated.

2. The method of claim 1, wherein the determining the target domain adapter from the plurality of candidate domain adapters comprises:
acquiring a first encoded feature of the information to be translated;
determining, according to the first encoded feature, first indication information of the information to be translated, wherein the first indication information characterizes a likelihood that each candidate domain adapter is the target domain adapter; and
determining, according to the first indication information, the target domain adapter corresponding to the information to be translated from the plurality of candidate domain adapters.

3. The method of claim 1, wherein the determining the target domain adapter from the plurality of candidate domain adapters comprises:
acquiring a first encoded feature of the information to be translated;
obtaining, based on the first encoded feature, a segment decoded feature of each target segment corresponding to the information to be translated;
obtaining, based on the segment decoded feature of each target segment, second indication information of the target segment; and
determining the target domain adapter of the target segment based on the second indication information of the target segment,
wherein the second indication information of each target segment characterizes the likelihood that each candidate domain adapter is the target domain adapter of the target segment,
wherein the obtaining the translation result corresponding to the information to be translated, comprises:
for each target segment, outputting, based on the segment decoded feature of the target segment and by the target domain adapter corresponding to the target segment, a respective translation result of the target segment.

4. The method of claim 3, wherein the obtaining the second indication information of the target segment, and the determining the target domain adapter of the target segment based on the second indication information of the target segment, comprises:
for each target segment, determining, based on a segment decoded feature of a respective target segment at a first decoding level, second indication information of the respective target segment; and
determining, based on the second indication information corresponding to the respective target segment at the first decoding level, a target domain adapter corresponding to the respective target segment at each decoding level.

5. The method of claim 3, wherein the obtaining, based on the segment decoded feature of each target segment, the second indication information of the target segment, and determining the target domain adapter of the target segment based on the second indication information of the target segment, comprise:
for each target segment, determining, according to a segment decoded feature of the target segment at each decoding level, a second indication information corresponding to a respective target segment at a respective decoding level, and determining, according to the second indication information corresponding to the respective target segment at the respective decoding level, a target domain adapter corresponding to the respective target segment at the respective decoding level,
wherein the second indication information corresponding to the respective target segment at the respective decoding level characterizes a likelihood that each candidate domain adapter is the target domain adapter corresponding to the respective target segment at the respective decoding level.

6. The method of claim 5, wherein the determining, according to the second indication information corresponding to the respective target segment at the respective decoding level, the target domain adapter corresponding to the respective target segment at the respective decoding level comprises:
determining, according to the second indication information corresponding to the respective target segment at the respective decoding level, the target domain adapter corresponding to the respective target segment at the respective decoding level from each candidate adapters corresponding to the respective decoding levels.

7. The method of claim 3, wherein the outputting, based on the segment decoded feature of the target segment and by the target domain adapter corresponding to the target segment, a translation result of each target segment comprises:
for each decoding level, converting, according to the segment decoded feature of the respective target segment at the respective decoding level and via the target domain adapter corresponding to the respective target segment at the respective decoding level to obtain the converted segment decoded feature, and outputting the converted segment decoded feature; and
outputting the translation result of the respective target segment according to the converted segment decoded feature output by the last decoding level.

8. The method of claim 3, further comprising:
for each target segment, acquiring the decoded feature of the respective target segment at each decoding level by:
for a first decoding level, obtaining a segment decoded feature of the target segment at the first decoding level, based on the first encoded feature and a second encoded feature of a translated segment prior to the target segment; and
for a second decoding level, obtaining a segment decoded feature of the target segment at the second decoding level, based on the first encoded feature and a converted segment decoded feature outputted by the target segment at the previous decoding level, and
wherein the first decoding level is a first decoding level of at least two decoding levels, and the second decoding level is any decoding level other than the first decoding level.

9. The method of claim 3, further comprising:
determining the first indication information of the information to be translated according to the first encoded feature of the information to be translated;
wherein the determining the target domain adapter of the target segment based on the second indication information of the target segment comprises:
for each target segment, determining the target domain adapter of the respective target segment according to the second indication information of the respective target segment and the first indication information.

10. The method of claim 9, wherein the determining the target domain adapter of the target segment according to the second indication information of the target segment and the first indication information comprises:
acquiring a first weight corresponding to the first indication information and a second weight corresponding to the second indication information;
weighting the first indication information and the second indication information based on the first weight and the second weight, respectively, to obtain third indication information; and
determining the target domain adapter of the target segment based on the third indication information.

11. The method of claim 10, wherein the acquiring the first weight corresponding to the first indication information and the second weight corresponding to the second indication information comprises:
for each target segment, determining the second weight based on a bit-order of the respective target segment, and obtaining the first weight based on the second weight;
wherein a second weight corresponding to one target segment is positively correlated to the bit-order.

12. The method of claim 3, wherein the obtaining the second indication information of the target segment based on the segment decoded feature of each target segment comprises:
for each target segment, obtaining the second indication information of the target segment based on a similarity between the segment decoded feature of the target segment and a domain feature vector of each candidate domain adapter.

13. The method of claim 3, wherein the obtaining the second indication information of the target segment based on the segment decoded features of each target segment comprises:
for each target segment, determining second indication information of the respective target segment, based on the segment decoded feature of the respective target segment, and a segment decoded feature of the translated segment prior to the respective target segment.

14. The method of claim 1, comprising:
displaying a list of translation domains, the list of translation domains comprising identification information of at least one candidate translation domain of a plurality of candidate translation domains;
acquiring a first input of a user, the first input for selecting a domain corresponding to translation from the list of translation domains; and
in response to the first input, downloading a domain adapter of the corresponding domain.

15. The method of claim 14, further comprising:
displaying update prompt information, the update prompt information for prompting an update to the domain corresponding to translation; and
in response to the acquired update indication, updating the domain adapter of the respective domain.

16. A method performed by an electronic device, comprising:
displaying a list of translation domains, the list of translation domains comprising identification information of at least one candidate translation domain of a plurality of candidate translation domains;
acquiring a first input of a user, the first input for selecting a translation domain from the list of translation domains;
in response to the first input, downloading a domain adapter of the corresponding domain.

17. The method of claim 16, further comprising:
displaying update prompt information, the update prompt information for prompting an update to the selected translation domain corresponding to translation;
in response to the acquired update indication, updating a domain adapter of the respective domain.

18. A method performed by an electronic device, comprising:
acquiring a dataset tag of a target dataset, the dataset tag characterizing a data distribution category of each data in the target dataset;
training a data distribution prediction module based on the target dataset and the dataset tag, the data distribution prediction module for predicting a probability that each data in the target dataset belongs to respective data distribution categories, wherein each data distribution category corresponds to at least one domain; and
based on the trained data distribution prediction module, training each candidate domain adapter to obtain a machine translation model, wherein each candidate domain adapter corresponds to at least one domain.

19. An electronic device, comprising:
one or more processors;
a memory;
one or more computer programs, wherein the one or more computer programs are stored in the memory and configured to be executed by the one or more processors, the one or more computer programs configured to: perform the method of claim 1.

20. A computer-readable storage medium for storing computer instructions that, when executed on a computer, enable a computer to perform the method of claim 1.
